(19) United States
(12) Patent Application Publication
(10) Pub. No.: US 2020/0302068 A1
(43) Pub. Date: Sep. 24, 2020

(54) METHOD FOR EXECUTING, WITH A MICROPROCESSOR, A BINARY CODE CONTAINING A CALLING FUNCTION AND A CALLED FUNCTION

(71) Applicant: Commissariat a l'Energie Atomique et aux Energies Alternatives, Paris (FR)

(72) Inventor: Olivier SAVRY, Grenoble Cedex 9 (FR)

(73) Assignee: Commissariat a l'Energie Atomique et aux Energies Alternatives, Paris (FR)

(21) Appl. No.: 16/823,441

(22) Filed: Mar. 19, 2020

(30) Foreign Application Priority Data
Mar. 21, 2019 (FR) 19 02952

(51) Int. Cl. G06F 21/60; G06F 9/22; G06F 9/30

(52) U.S. Cl. CPC G06F 21/602; G06F 9/3005; G06F 9/223

(57) ABSTRACT

A method for executing, with a microprocessor, a binary code, this method including executing a prologue of a function called by a microprocessor, this execution including encrypting a return address of the calling or called function and saving the return address thus encrypted in a call stack, this encryption being carried out using a first value that is not used when data are saved in the call stack by the called function and that is independent of the address at which the return address thus encrypted is saved in the call stack, then executing an epilogue of the function called by the microprocessor, this execution including decrypting, using the first value, the encrypted return address saved in the call stack, then branching to an instruction line identified by this decrypted return address.

The invention relates to a method for executing, with a microprocessor, a binary code containing a calling function and a called function, which is called by this calling function. The invention also relates to:
a binary code, a data-storage medium and a microprocessor for implementing this executing method, and
a compiler for generating this binary code.

To obtain information on a binary code or to cause the binary code to function in an unexpected way, many attacks are possible. For example buffer overflow attacks may be carried out. These attacks consist in replacing, in a call stack, the return address of the called function by another address set by the attacker. A buffer overflow may therefore be used to execute a code developed and designed by the attacker.

Using such attacks, an attacker can determine a secret key of a cryptographic system, bypass security mechanisms such as the verification of a PIN code during an authentication or simply prevent the execution of a function essential to the security of a critical system.

These attacks therefore cause an execution fault that, during the execution of the binary code, alters the control flow of the machine code.

The control flow corresponds to the order of execution followed during the execution of the machine code. Control flow is conventionally represented in the form of a graph known as the control flow graph.

The binary code of a function may be written to allow execution faults to be detected and signalled. When the binary code of a function is thus written, this binary code is qualified “binary code of a secure function”. Specifically, contrary to the binary code of an insecure function, this binary code is able to allow execution faults typically encountered in case of attacks to be signalled.

Various solutions have already been proposed for combating buffer overflow attacks. For example, mention may be made of the following solutions:
the software solution known as the “canary technique”,
hardware solutions such as a hardware module that verifies that each datum stored in the call stack is correctly confined to the address range that is allocated thereto,
the storage of the return addresses not only in the call stack but also in a hidden stack not accessible to users.

These known solutions function correctly. However, they consume a substantial proportion of the memory space allocated to the call stack or require the use of hardware modules that are very specific to this task.

The objective here is to propose another method for executing a binary code that makes it more difficult to carry out buffer overflow attacks.

Therefore, one subject of the invention is a method for executing, with a microprocessor, a binary code containing a calling function and a called function, which is called by this calling function.

Another subject of the invention is a binary code, executable by a microprocessor, for implementing the executing method.

Another subject of the invention is a data-storage medium that is readable by a microprocessor, this data-storage medium containing the binary code.

Another subject of the invention is a microprocessor for implementing the executing method.

Lastly, another subject of the invention is a compiler able to automatically convert a source code of a function into a binary code of this function, wherein the compiler is able to automatically convert the source code into a binary code as claimed.

The invention will be better understood on reading the following description, which is given merely by way of nonlimiting example and with reference to the drawings, in which:

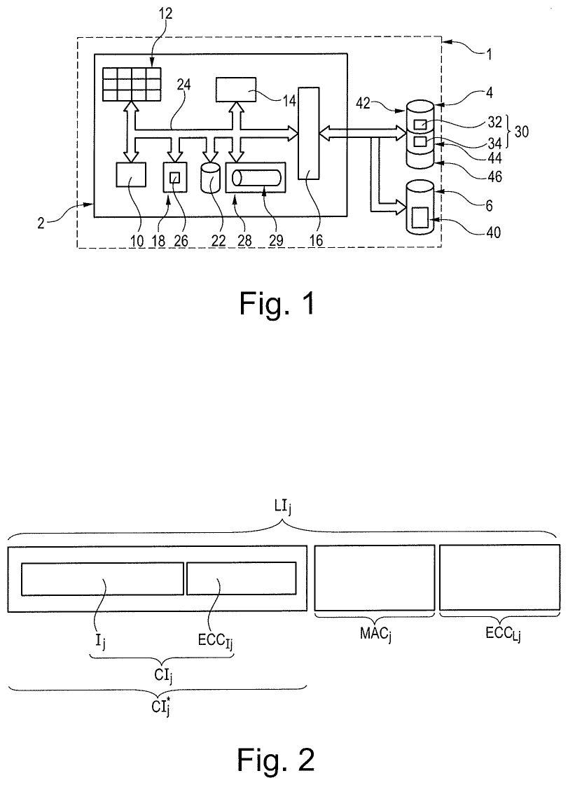

FIG. 1 is a schematic illustration of the architecture of an electronic device able to execute a binary code of a secure function;

FIG. 2 is a schematic illustration of the structure of an instruction line coding an instruction of the binary code executed by the device of FIG. 1;

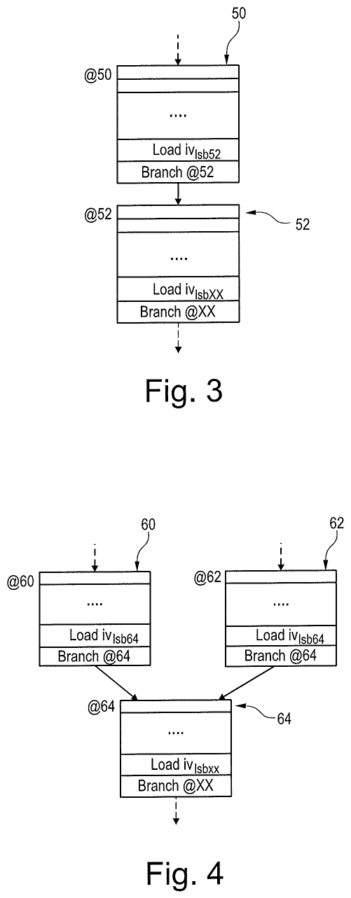

FIGS. 3 to 5 are schematic illustrations of various segments of the binary code of the secure function capable of being executed by the device of FIG. 1;

FIG. 6 is a schematic illustration of various registers of the electronic device, said registers being used during the execution of the secure function;

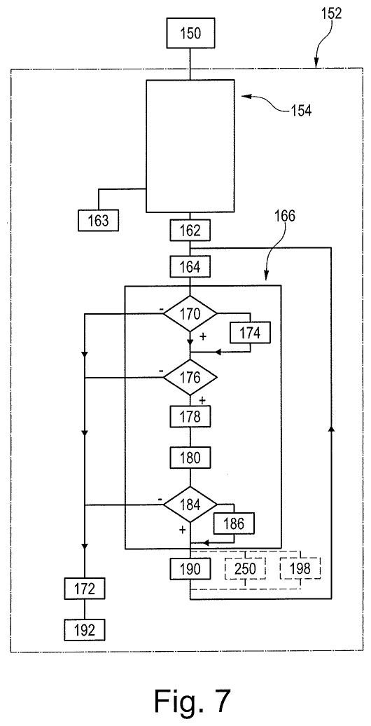

FIG. 7 is a flowchart of a method for executing the binary code of the secure function;

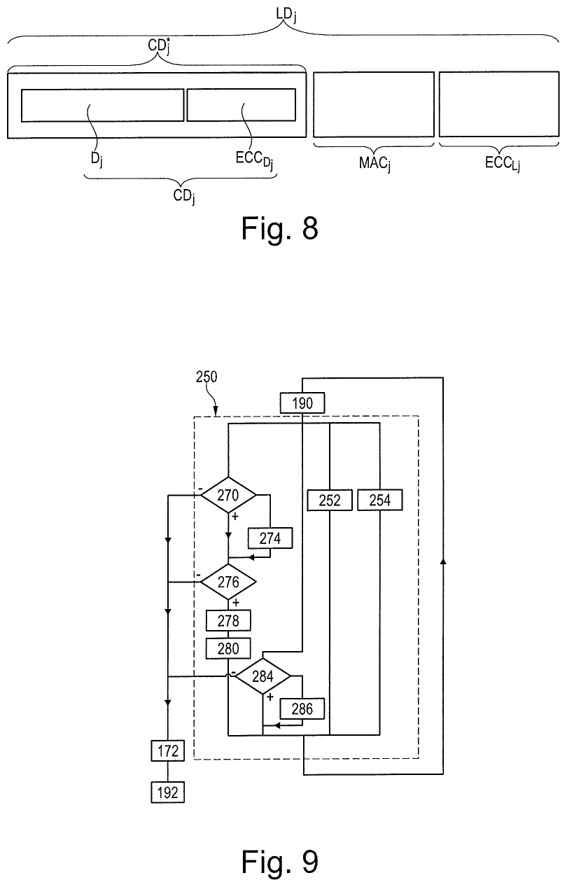

FIG. 8 is a schematic illustration of the structure of a data line of the binary code executed by the device of FIG. 1;

FIG. 9 is a flowchart of a detail of a step of the method of FIG. 7 employed to secure the data stored in a call stack of the device of FIG. 1;

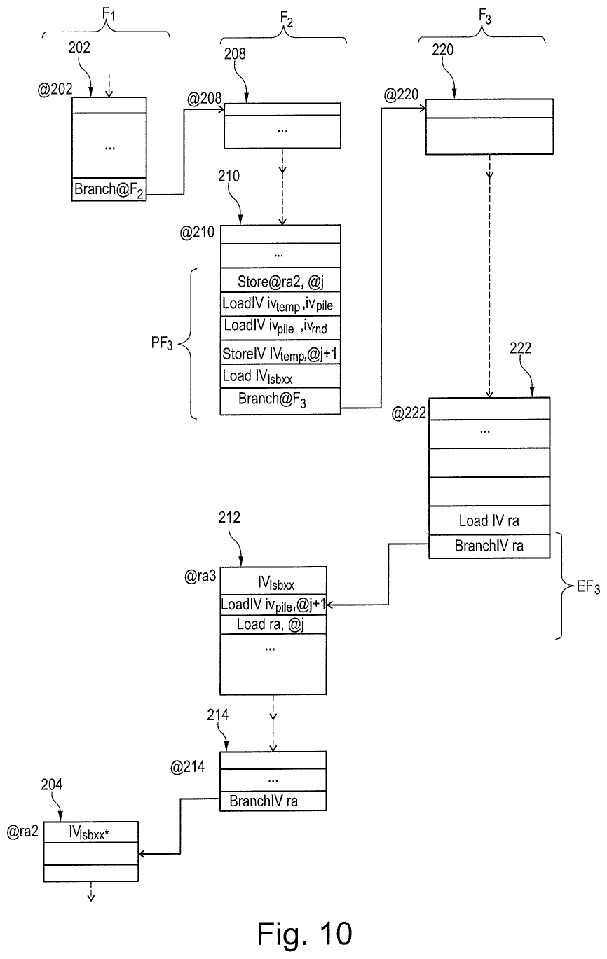

FIG. 10 shows schematic illustrations of various segments of the binary code of the secure function capable of being executed by the device of FIG. 1;

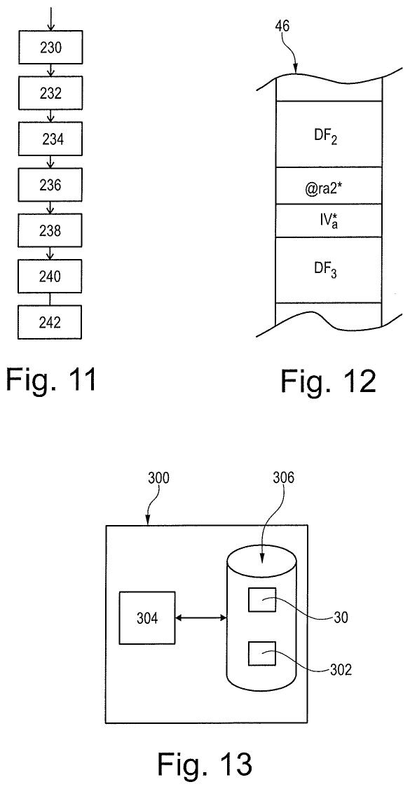

FIG. 11 is a flowchart of a detail of a step of the method of FIG. 6 employed to make buffer overflow attacks more difficult;

FIG. 12 is a schematic illustration of a call stack of the device of FIG. 1;

FIG. 13 is a schematic illustration of a compiler able to generate the binary code executed by the device of FIG. 1.

### SECTION I: CONVENTIONS, NOTATIONS AND DEFINITIONS

In the figures, the same references have been used to designate the same elements. In the rest of this description, features and functions well known to those skilled in the art are not described in detail.

In this description, the following definitions have been adopted.

A “program” designates a set of one or more predefined functions that it is desired to make a microprocessor execute.

A “source code” is a representation of the program in a computer language, not being directly executable by a microprocessor and being intended to be converted by a compiler into a machine code directly executable by the microprocessor.

A program or code is said to be “directly executable” when it is able to be executed by a microprocessor without this microprocessor needing beforehand to compile it by means of a compiler or to interpret it by means of an interpreter.

An “instruction” designates a machine instruction executable by a microprocessor. Such an instruction consists of:
an opcode, or operation code, coding the nature of the operation to be executed, and
one or more operands defining the one or more values of the parameters of this operation.

A “machine code” is a set of machine instructions. It is typically a question of a file containing a succession of bits having the value “0” or “1”, these bits coding the instructions to be executed by the microprocessor. The machine code is directly executable by the microprocessor, i.e. without requiring compilation or interpretation beforehand.

A “binary code” is a file containing a succession of bits having the value “0” or “1”. These bits code data and instructions to be executed by the microprocessor. Thus, the binary code contains at least one machine code and in addition, generally, digital data processed by this machine code.

An “instruction flow” is a succession of instructions arranged one after the other and that forms, in the machine code, an ordered succession of bits. The instruction flow starts with an initial instruction and ends with a final instruction. With respect to a given instruction of the instruction flow, the instructions located on the side of the initial instruction are called “preceding instructions” and the instructions located on the side of the final instruction are called “following instructions”. In this text, this instruction flow is divided in memory into a succession of basic blocks that are immediately consecutive or separated by data blocks.

In this text, a “basic block” is a group of successive instructions of the instruction flow that starts at a branch address and that ends with a single explicit or implicit branch instruction. An explicit branch instruction is characterized by the explicit presence of an opcode in the machine code that codes the branch instruction. An implicit branch instruction corresponds to the case where the execution of a proceeding basic block systematically continues with the execution of a following basic block located, in the machine code, immediately after the preceding basic block. In this case, given that in absence of explicit branch instruction, the instructions of the machine code are executed in order one after the other, it is not necessary to insert, at the end of the preceding basic block, an explicit instruction to branch to the following basic block. In this description, in this case the preceding basic block is said to end with an implicit branch instruction because this instruction is not explicitly coded in the machine code. In this case, the preceding basic block ends just before the branch address of the following basic block. In this application, the expression “branch instruction” designates an explicit branch instruction unless otherwise mentioned. Thus, the execution of a basic block systematically starts with the execution of its first instruction and systematically ends with the execution of the branch instruction that ends this basic block. A basic block contains no other branch instructions than that located at the end of this basic block. Thus, the instructions of a basic block are systematically all read by the microprocessor one after the other in the order that they are present in this basic block. The branch instruction may direct, when it is executed, the control flow systematically to the same branch address or, alternatively, to different branch addresses. The latter case is encountered, for example, when, at the end of the executed basic block, the control flow may continue to a first or alternatively to a second basic block.

A “branch instruction” is an instruction that, when it is executed by the microprocessor, triggers a jump to the branch address of another basic block. Typically, to this end, this instruction replaces the current value of the program counter with the value of the branch address. It will be recalled that the program counter contains the address of the next instruction to be executed by the microprocessor. In the absence of branch instruction, each time an instruction is executed, the program counter is incremented by the size of the instruction currently being executed. In the absence of branch instruction, the instructions are systematically executed sequentially one after the other in the order in which they are stored in a main memory. The branch instruction may be unconditional, i.e. the jump to the branch address is systematically carried out as soon as this instruction is executed. An unconditional branch instruction is for example the “JAL” instruction in the RISC-V instruction set. The branch instruction may also be conditional, i.e. the jump to the branch address is triggered on the execution thereof solely if a particular condition is met. For example, a conditional branch instruction is a “BRANCH” instruction in the RISC-V instruction set. The branch instruction may also be a call to a function. In this text, unless otherwise indicated, the term “branch instruction” designates both direct and indirect branch instructions. A direct branch instruction is a branch instruction that directly contains the numerical value of the branch address. An indirect branch instruction is an instruction to branch to a branch address contained in a memory or a register of the microprocessor. Thus, contrary to a direct branch instruction, an indirect branch instruction does not directly contain the numerical value of the branch address. For example, an indirect branch instruction is the “JALR” instruction of the RISC-V instruction set.

A “branch address” is the address in the main memory at which the first instruction line of a basic block is located. Below, branch address is spoken of even for basic blocks the first instruction of which is executed following the execution of an implicit branch instruction.

Execution of a function is spoken of to designate the execution of the instructions that perform this function.

For the sake of simplicity, in this description and in the figures, the instructions have not been shown in binary form, but rather in a symbolic form expressed in a higher-level language.

### SECTION II: ARCHITECTURE OF THE DEVICE

FIG. 1 shows an electronic device 1 comprising a microprocessor 2, a main memory 4 and a bulk storage medium 6. For example, the device 1 is a computer, a smart phone, a tablet computer or the like.

The microprocessor 2 here comprises:
an arithmetic logic unit 10;
a set 12 of registers;
a control module 14;
a data input/output interface 16,
a loader 18 of instructions including a program counter 26,
a queue 22 of instructions to be executed, and
a hardware security module 28.

The memory 4 is configured to store the instructions and data of a binary code 30 of a program that must be executed by the microprocessor 2. The memory 4 is a random-access memory. Typically, the memory 4 is a volatile memory. The memory 4 may be a memory external to the microprocessor 2 as shown in FIG. 1. In this case, the memory 4 is produced on a substrate that is mechanically separate from the substrate on which the various elements of the microprocessor 2 such as the unit 10 are produced.

Here, the memory 4 is divided into successive machine words of fixed length. Each machine word may be transferred in a single clock cycle from the memory 4 to a register of the microprocessor. To this end, the size N_{MM} of a machine word is equal to the maximum number of bits that can be simultaneously transferred from the memory 4 to a register of the set 12. Here, the size N_{MM} is strictly larger than Nᵢₙₛₜ bits, where Nᵢₙₛₜ bits is the number of bits of the instructions of the instruction set of the microprocessor 2. Typically, Nᵢₙₛₜ is an integer higher than or equal to 8, 16, 32 or 64. In this example, Nᵢₙₛₜ is equal to 32 and the size N_{MM} is equal to 128 bits.

Conventionally, the memory 4 is mainly divided into three portions:
a first portion 42 containing the instructions to be executed,
a second portion 44 containing the data to be processed, and
a third portion 46 used to save the execution context of a function when it calls another function.
   The portion 46 is known as the call stack. Therefore, below the portion 46 is also referred to as the “stack 46”.

The binary code 30 notably comprises a machine code 32 of a secure function and a block 34 of data required to execute the binary code 30. The machine code 32 and the block 34 are stored in the portions 42 and 44, respectively.

Each secure function corresponds to a set of a plurality of lines of code, for example several hundred or thousand lines of code, which are stored at successive addresses in the memory 4. Here, each code line corresponds to one machine word. Thus, one line of code is loaded into a register of the microprocessor 2 in a single read operation. Likewise, one line of code is written to the memory 4 by the microprocessor 2 in a single write operation. Each line of code corresponds to a single instruction or to a single datum. Below, when the line of code contains an instruction, it is referred to as a “instruction line”. When the line of code contains a datum, it is referred to as a “data line”. The structures of an instruction line and of a data line are described in detail with reference to FIGS. 2 and 8.

The block 34 is typically located in a predefined address range at the start of the binary code 30. Thus, the execution of the binary code 30 starts with the loading and processing of the data of the block 34. Here, the block 34 notably comprises:
a cryptogram ka* obtained by encrypting a key ka using a public key pk_{CPU} of the microprocessor 2, and
cryptograms iv_{msbi}*, iv_{ctei}*, iv_{lsbi}, iv_{msbd}*, iv_{cted}*, ivₚᵢₗₑ*, iv_{ctep}*, encrypted using the public key pk_{CPU}, of various values intended to initialize the content of various registers of the microprocessor 2 in order to allow the binary code 30 to be decrypted.

By way of illustration, the microprocessor 2 has an RISC (Reduced Instruction Set Computer) architecture and employs the RISC-V instruction set.

Here, the unit 10 is an arithmetic logic unit of Nᵢₙₛₜ bits.

The loader 18 loads into the queue 22 the next instruction to be executed by the unit 10 from the portion 42 of the memory 4. More precisely, the loader 18 loads the instruction to which the program counter 26 points.

The unit 10 is notably configured to execute, one after the other, instructions loaded into the queue 22. The instructions loaded into the queue 22 are generally systematically executed in the order in which these instructions were stored in this queue 22. The unit 10 is also capable of storing the result of these executed instructions in one or more registers of the set 12.

In this description, “execution by the microprocessor 2” and “execution by the unit 10” will be used as synonyms.

The module 14 is configured to move data between the set 12 of registers and the interface 16. The interface 16 is notably able to acquire data and instructions, for example, from the memory 4 and/or the medium 6 external to the microprocessor

The module 28 is capable of automatically executing the various operations described in detail in the following sections in order to secure the execution of the secure functions. The module 28 functions independently and without using the unit 10. Thus, it is capable of processing lines of code before and/or after the latter are processed by the unit 10. To this end, it notably comprises a secure non-volatile memory 29. This memory 29 can only be accessed through the module 28. In this embodiment, the module 28 is programmed beforehand, for example during its design, to execute operations such as the following operations:
verifying the integrity and authenticity of a datum via a message authentication code (MAC),
constructing a message authentication code,
encrypting a datum to obtain a cryptogram,
decrypting a cryptogram to obtain a plaintext datum,
executing a preprogrammed function Fᵢᵥ.

The memory 29 is used to store the secret information required to implement the method of FIG. 6. Here, it therefore notably contains secret information stored beforehand before the start of the execution of the binary code 30. In particular, it contains the following information stored beforehand:
a secret key k′ used to verify the message authentication codes,
a secret private key sk_{CPU} that allows the data that were encrypted using the public key pk_{CPU} to be decrypted.

In this example of an embodiment, the set 12 comprises general registers that are usable to store any type of data. The size of each of these registers is, for example, equal to N_{MM}.

A data exchange bus 24 that links the various components of the microprocessor 2 to one another is shown in FIG. 1 in order to indicate that the various components of the microprocessor may exchange data between one another.

The medium 6 is typically a nonvolatile memory. For example, it is an EEPROM or flash memory. It here contains a backup copy 40 of the binary code 30. Typically, this copy 40 is automatically copied to the memory 4 to restore the code 30, for example, after an interruption in current or similar, or just before the execution of the code 30 starts.

### SECTION III: SECURING THE MACHINE CODE

Here, the structure of the machine code of the secure function is described in the particular case of the machine code 32. However, what is described in this particular case may be transposed without difficulty to any machine code of a secure function.

The machine code 32 comprises a succession of instruction lines LIⱼ stored one after the other in the memory 4. Below, in this section, the index j is used to identify the instruction line LIⱼ among the other instruction lines of the machine code 32. In addition, the index j is also used as an order number indicating in which order the lines LIⱼ are classed. Thus, the instruction line located immediately after the line LIⱼ is denoted LIⱼ₊₁. Each instruction line LIⱼ codes one instruction of the instruction set of the microprocessor 2, this line being executable after decryption and decoding by the unit 10 of this microprocessor.

The structures of all the lines LIⱼ are identical. This structure is shown in detail in FIG. 2 in the particular case of the line LIⱼ.

The line LIⱼ comprises a cryptogram CIⱼ*, a code MACⱼ, and a code ECC_{Lj}.

The cryptogram CIⱼ* is obtained by encrypting a concatenation CIⱼ using the secret key ka and an initialization vector ivₖ. More precisely, the cryptogram CIⱼ* is obtained using the following relationship: CIⱼ*=fₖₐ(CIⱼ; ivₖ), where fₖₐ is an encryption function corresponding to a decryption function fₖₐ⁻¹ programmed beforehand in the module 28. Typically, the function fₖₐ is a symmetric encryption function. Thus, the key ka allowing the cryptogram CIⱼ* to be decrypted is stored beforehand in the memory 29 in order to allow the module 28 to decrypt this cryptogram CIⱼ*. The initialization vector ivₖ is constructed as described below in this section.

The concatenation CIⱼ is here the concatenation of an instruction Iⱼ to be executed by the microprocessor 2 and of a code ECC_{Ij}. The code ECC allows an error to be detected in the instruction Iⱼ and, potentially, this error to be corrected. For example, the code ECC_{Ij} may be the code known by the acronym BCH (Bose, Ray-Chaudhuri, Hocquenghem), which has the advantage of being particularly easy to implement. However, any other known error detection or correction code may be employed. The size of the code ECC_{Ij} is larger than or equal to 1 or 2 or 3 bits and, generally, smaller than Nᵢₙₛₜ. The size of the code ECC_{Ij} is dependent on the desired robustness. The larger the number of erroneous bits that it is desired to be capable of correcting in the instruction Iⱼ, the larger the size of the code ECC_{Ij} will be.

The code MACⱼ is a code allowing the integrity and authenticity of the cryptogram CIⱼ* to be verified. This code is commonly called a “message authentication code” (MAC). Such a code MACⱼ is obtained by constructing a label from the cryptogram CIⱼ*, which normally contains fewer bits than the cryptogram CIⱼ*. This label is constructed using a preset function and the secret key k′ known only to the author of the binary code 30 and to the microprocessor 2. Here, the key k′ is stored beforehand in the memory 29. For example, the preset function is a hash function. In this case, generally, the label is the result of the application of this hash function to a combination, for example a concatenation of the cryptogram CIⱼ* and of the key k′.

By way of example, to generate the cryptogram CIⱼ* and the code MACⱼ, an authenticated encryption algorithm is used. This authenticated encryption algorithm may be chosen from the various entrants to the CAESAR (Competition for Authenticated Encryption: Security, Applicability, and Robustness) such as for example one of the algorithms designated by the following names: “ACORN”, “ASCON”, “SILC”, “CLOC”, “JAMBU”, “KETJE”.

The code ECC_{Lj} is an error correction code that allows an error in the cryptogram CIⱼ* and code MACⱼ to be detected and corrected. It is for example constructed as described in the case of the code ECC_{Ij}.

The cryptogram CI_{Ij}* and the codes ECC_{Ij}, MACⱼ and ECC_{Lj} are, typically, constructed at the moment at which the machine code 32 is generated.

Below, the address @ⱼ in the memory 4 at which the line LIⱼ is stored will be noted.

The machine code 32 is composed of a succession of basic blocks that must be executed one after the other. Here, the basic blocks may have a structure of a first or second type. Below, basic blocks that have a structure of the first type and a structure of the second type are called “block of the first type” and “block of the second type”, respectively. The first type of structure is used in the case of direct branching. The second type of structure is used in the case of indirect branching.

FIG. 3 shows the first type of structure. More precisely, FIG. 3 shows a first arrangement of two basic blocks 50 and 52 of the machine code 32. In this first arrangement, the basic blocks 50 and 52 are systematically executed one after the other. In the order of execution, the basic block 50 precedes the basic block 52. In this figure and the following figures:
the order of execution of the basic blocks is represented by an arrow that points from the preceding basic block to the following basic block,
a dashed arrow that points to a shown basic block indicates that the one or more basic blocks that precede this basic block have not been shown to simplify the figure,
a dashed arrow that points into empty space from a shown basic block indicates that the one or more basic blocks following this shown basic block have not been shown to simplify the figure,
the symbol “ . . . ” inside a basic block indicates that all the instruction lines of this basic block have not been shown.

Each basic block is composed of a succession of instruction lines that each contain the cryptogram CIⱼ* of the instruction Iⱼ to be executed and the code MACⱼ. In addition, each basic block starts with a branch address and ends with an instruction line that contains the cryptogram of a branch instruction. More precisely, in the case of the first type of structure, the first line of the basic block, i.e. the line located at the branch address, is the first instruction line of the basic block. Basic blocks of the first type contain no data line.

In FIG. 3, the symbols “@50” and “@52” beside the first line of each basic block designate the branch addresses of the basic blocks 50 and 52, respectively. The symbol “@XX” designates the branch address of another basic block (not shown in FIG. 3).

The symbol “Load iv_{lsbXX}” indicated in the penultimate instruction line of the basic block indicates that this instruction line contains the cryptogram of a direct load instruction. When the direct load instruction is executed by the microprocessor 2, it causes a new value iv_{lsbXX} to be loaded into a register iv_{branch} of the microprocessor 2. The value iv_{lsbxx} is contained directly in the instruction “Load iv_{lsbxx}”. In other words, the value iv_{lsbxx} is an operand of the “Load iv_{lsbxx} instruction. It will be noted that the value iv_{lsbxx} is here coded on 32 bits and therefore has the same length as an instruction. Thus, although in this text a direct load instruction is spoken of, in practice this instruction is generally implemented in the form of first and second instructions of 32 bits of the instruction set of the microprocessor 2. Typically, when they are executed, the first instruction loads a first portion of the bits of the value iv_{lsbxx} into the register iv_{branch} and the second instruction loads the other bits of the value iv_{lsbxx} into this register iv_{branch}.

The symbol “xx” in the value iv_{lsbxx} is an identifier of this value. Specifically, each time the instruction “Load iv_{lsbxx}” is executed, it causes a specific value to be loaded that allows the instruction lines of the following basic block to be decrypted. Thus, the symbol “Load iv_{lsb52}” indicates that the value iv_{lsb52} is loaded into the register iv_{branch} before the start of the execution of the basic block 52.

The symbol “Branch @XX” indicated in the last instruction line of the basic block indicates that the latter line contains the cryptogram of a direct branch instruction that, when it is executed by the microprocessor 2, causes a direct branch to the branch address @XX. When it is executed, this instruction also causes the value contained in the register iv_{branch} to be loaded into a register iv_{lsbi} of the microprocessor 2. The register iv_{lsbi} contains the 32 least significant bits of the initialization vector ivₖ currently being used to decrypt the instruction lines.

In this embodiment, the vector ivₖ is coded on 128 bits. The 32 most significant bits are stored in a register iv_{msbi}. The 64 bits located between the 32 least significant bits and the 32 most significant bits are stored in one or more registers that are collectively designated by the term “register iv_{ctei}”. Each vector ivₖ is therefore the result of the concatenation of the bits of the registers iv_{msbi}, iv_{ctei} and iv_{lsbi}. Here, the values contained in the registers iv_{msbi} and iv_{ctei} remain constant throughout the execution of the machine code. For example, the registers iv_{msbi} and iv_{ctei} are loaded with these constant values at the start of the execution of the machine code 32. These constant values are obtained by decrypting the cryptograms iv_{msbi}* and iv_{ctei}* contained in the block 34.

The same initialization vector ivₖ is used to decrypt all the cryptograms CIⱼ* of all the instruction lines of the same basic block BBₖ. The index k unambiguously identifies the basic block BBₖ among all the basic blocks of the machine code 32. In the figures and in the description below, the symbol ivₖ is used to designate, in a general way, the initialization vector to be used to decrypt the instruction lines of the basic block BBₖ. In addition, in simple cases such as that shown in FIG. 3 in which two basic blocks follow in the order of execution of the machine code 32, the index k is also used to indicate the order in which these basic blocks are executed. For example, the notation BBₖ₋₁ is, in these simple cases, used to designate the preceding basic block systematically executed immediately before the basic block BBₖ.

Here, the initialization vector ivₖ is unique to each basic block BBₖ. By “unique to each basic block” what is meant is the fact that the probability that two different basic blocks of the machine code 32 are encrypted with the same initialization vector ivₖ is lower than one chance in 100 or in 1000. In particular, the expression “unique to each basic block” therefore covers the case where the initialization vectors ivₖ of all the basic blocks are systematically different from one another. For example, in a simple embodiment, during the generation of the code 32, the 32 least significant bits of the initialization vectors ivₖ of each basic block are drawn randomly or pseudo-randomly from the set {1; . . . ; 2^{Ninst}}.

As shown in FIG. 3, in the code 32, the 32 least significant bits of the initialization vector ivₖ are loaded into the register iv_{branch} solely during the execution of a basic block preceding the basic block BBₖ. In FIG. 3, the initialization vector iv_{lsb52} required to decrypt the block 52 is loaded during the execution of the block 50.

FIG. 4 shows another possible arrangement of a plurality of basic blocks of the code 32 in the particular case of two preceding basic blocks 60 and 62 and of one following basic block 64. The blocks 60, 62 and 64 are basic blocks of the first type. Here, the blocks 60 and 64 are, for example, identical to the blocks 50 and 52, respectively, except that the 32 least significant bits of the initialization vector of the block 64 are denoted “iv_{lsb64}”. The block 62 is constructed as the block 60 and, in particular, it ends with two instruction lines that code the same instructions as those coded in the last two lines of the block 60. However, even though these last two lines code the same instructions, the cryptograms of these instructions are different because the block 62 is encrypted using an initialization vector iv₆₂ different from the vector iv₆₀ used to encrypt the block 60. The other instruction lines of the block 62 are different from those of the block 60.

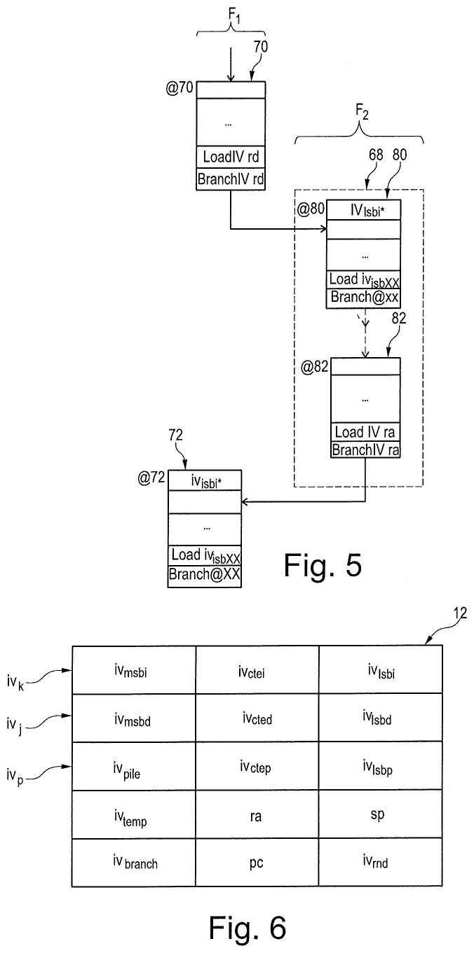

FIG. 5 shows one portion of the architecture of the machine code 32 when a function F₁ of the machine code 32 calls an external function F₂. To this end, the machine code of the function F₁ contains a basic block 70 that ends with a call to the machine code 68 of the function F₂.

The machine code 68 is arranged as described for the machine code 32. It is therefore composed of a succession of basic blocks. To simplify FIG. 5, only the first basic block 80 and the last basic block 82 of this machine code 68 have been shown. Here, when the execution of the function F₂ has ended, i.e. after the execution of the block 82, the execution of the machine code 32 continues with the execution of a basic block 72.

The instruction lines of the blocks 70, 72, 80 and 82 are encrypted using vectors iv₇₀, iv₇₂, iv₈₀ and iv₈₂, respectively.

Here, the machine code 32 is a dynamic code that was generated independently of the machine code 68. For example, the machine code 68 was generated before or after the machine code 32 was generated. For example, the machine code 68 is the code of a function of a library of functions stored beforehand. In this case, typically, the machine code 68 may be called, at different times, by various machine codes. The address @80 of the block 80 is therefore not known at the moment at which the machine code 32 is compiled. For this reason, the block 70 ends with an instruction line containing the cryptogram of an indirect branch instruction denoted “BranchIV rd” in FIG. 5. When the instruction “BranchIV rd” is executed by the microprocessor 2, it causes a jump to a branch address @ⱼ constructed from the current content of a register rd of the microprocessor 2. The address @ⱼ is typically constructed from the content of the register rd using the following relationship: @ⱼ=rd+offset+4, where:
@ⱼ is the constructed address,
rd is the value contained in the register rd,
“offset” is a preset numerical value, and
the symbol “+4” indicates that a constant value is added to the result of the sum rd+offset so that the address @ⱼ is equal to the address of the instruction line that immediately follows that located at the address rd+offset.
   Conventionally, the value “offset” is passed as an operand of the instruction “BranchIV rd”.

At this stage, it will be noted that when the sum rd+offset corresponds to the address of the first line of a basic block, the sum rd+offset+4 corresponds to the address of the second line of this basic block. Thus, contrary to a conventional indirect branch instruction, the instruction “BranchIV” causes a jump directly to the second line of the following basic block. The first line of this following basic block is therefore not executed in this embodiment.

The register rd is loaded with a value allowing the address @80 to be constructed. Typically, the register rd is loaded with the value that allows the address @80 to be constructed, at the start of the execution of the binary code 30, by a dynamic library loader or “loader” for short. This dynamic library loader is, for example, that of an operating system executed by the microprocessor 2. Since the mechanism of dynamic library loaders is well known, it will not be described here.

Likewise, since the machine code 68 to be executed is not known at the moment of compilation of the machine code 32, the vector iv₈₀ to be used to decrypt the instruction lines of this block 80 is also not known. It is therefore not possible to insert, during the compilation of the machine code 32, the instruction “Load iv_{isb80}”, which was described above, into the block 70 in order to cause the vector iv_{isb80} to be directly loaded into the register iv_{branch}. Instead, during the generation of the machine code 32, an instruction to indirectly load an initialization vector, which instruction is denoted “LoadIV rd”, is inserted just before the instruction “BranchIV rd”. When it is executed by the microprocessor 2, the instruction “Load IV rd” causes:
the content of the data line located at an address constructed from the content of the register rd to be read, then
the 32 least significant bits of the vector iv₈₀ to be constructed from the content of the read data line, then
the 32 least significant bits thus constructed to be loaded into the register iv_{branch}.

Here, in the case of the instruction “LoadIV rd”, an address is constructed from the content of the register rd using the following relationship: @ₖ=rd+offset, where “rd” and “offset” are the same as those used in the instruction “BranchIV rd”. Thus, the constructed address is the address of the first line of the following basic block. Below, the address of the first line of the basic block BBₖ is denoted @ₖ.

The block 80 is a basic block of the second type. A basic block BBₖ of the second type is identical to a basic block of the first type except that the first line of this basic block contains a data line LDₖ and not an instruction line. This line LDₖ contains the data allowing the 32 least significant bits of the initialization vector ivₖ used to encrypt the instruction lines of this basic block BBₖ to be constructed. To this end, it contains a cryptogram, denoted iv_{lsbi}* in the figures, of the 32 least significant bits of the vector ivₖ. In this embodiment, the cryptogram iv_{lsbi}* is obtained using the following relationship iv_{lsbi}*=fₖₐ(iv_{lsbi}; ivⱼ), where:
iv_{lsbi} is the value of the 32 least significant bits of the vector ivₖ,
ivⱼ is an initialization vector, different from the vector ivₖ, used to encrypt the data lines, and
the function fₖₐ is the same as that described above in the case of the encryption of the instructions.

The structure of a data line such as the line LDₖ is described below with reference to FIG. 8.

Similarly to as described for the vector ivₖ, the vector ivⱼ is coded on 128 bits. The 32 most significant bits are stored in a register iv_{msbd}. The 32 least significant bits are stored in a register iv_{lsbd}. The 64 bits located between the 32 least significant bits and the 32 most significant bits are stored in one or more registers collectively designated by the term “register iv_{cted}”. Each vector ivⱼ is therefore the result of the concatenation of the bits of the registers iv_{msbd}, iv_{cted} and iv_{lsbd}. Here, the contents of the registers iv_{msbd} and iv_{cted} remain constant throughout the execution of the machine code. For example, the registers iv_{msbd} and iv_{cted} are loaded with these constant values at the start of the execution of the machine code 32. Preferably, the values loaded into the registers iv_{msbd} and iv_{cted} are different from those loaded into the registers iv_{msbi} and iv_{ctei}.

The content of the register iv_{lsbd}, which is used to encrypt the data, depends on the address @ₖ at which the line LDₖ is stored. Specifically, the module 28 contains a function Fᵢᵥ programmed beforehand that, with each address @ⱼ of the memory 4, associates a different value of the register iv_{lsbd}. For example, the function Fᵢᵥ is a hash or encryption function. There is therefore the following relationship: iv_{lsbd}=Fᵢᵥ(@ⱼ), where iv_{lsbd} designates the content of the register iv_{lsbd}.

The machine code 68 may be called from various basic blocks of the machine code 32 or from various machine codes. Thus, the basic block that must be executed after the basic block 82 depends on the basic block that called the machine code 68. It is not known at the moment of generation of the machine code 68. Therefore, just like the block 70, the basic block 82 is a basic block of the first type that ends with an instruction line that codes an instruction “LoadIV ra” followed by an instruction line that codes the instruction “BranchIV ra”. The instructions “LoadIV ra” and “BranchIV ra” are identical to the instructions “LoadIV rd” and “BranchIV rd” described above, respectively, except that the register rd is replaced by the register ra.

When the code 68 is called from the block 70, the return address @72 of the machine code 68 is typically saved in the register ra of the microprocessor 2. If the machine code 68 itself calls another function, then the address @72 is saved in the call stack 46 and re-saved in the register ra just before the instructions “LoadIV ra” and “Branch IV ra” of the block 82 are executed.

The block 72 is a basic block of the second type. Its first line at the address @72 is therefore a data line that contains the cryptogram iv_{lsbi}* required to construct the vector iv₇₂ that allows its instruction lines to be decrypted.

FIG. 6 shows the main registers described up to now. These registers may be registers of the set 12 and/or registers of the module 28. Preferably, the registers of the module 28 are used to store the information used to encrypt or decrypt. Thus, preferably, the registers iv_{msbi}, iv_{ctei}, iv_{lsbi}, iv_{msbd}, iv_{cted}, iv_{lsbd}, ivₚᵢₗₑ, iv_{ctep}, iv_{isbp}, ivₜₑₘₚ, iv_{branch}, iv_{rnd} are registers contained in the memory 29. In addition to the registers already described, the microprocessor 2 comprises registers iv_{cted}, iv_{lsbd}, ivₚᵢₗₑ, iv_{ctep}, iv_{lsbp}, ivₜₑₘₚ, iv_{branch}, iv_{rnd} and sp, which are described in more detail in the following sections.

FIG. 7 shows a method for executing the binary code 30 with the microprocessor 2.

The method starts with a step 150 of delivering the binary code 30 to the memory 4. To do this, for example, the microprocessor 2 copies the copy 40 to the memory 4 to obtain the binary code 30 stored in the memory 4.

Next, in a phase 152, the microprocessor 2 executes the binary code 30 and, in particular, the machine code 32.

Optionally, the execution of the binary code 30 starts with a step 154 of authenticating the author of this binary code. If all the authentication was carried out with success, then the method continues with a step 162. In contrast, if the authentication was not carried out with success, the module 28 then considers the authentication of the author of the binary code 30 to have failed and the method continues with a step 163. In the step 163, the execution of the binary code 30 is stopped.

In step 162, the module 28 loads the cryptograms ka* and iv_{msbi}*, iv_{ctei}*, iv_{isbi}*, iV_{msbd}*, kf_{cted}*, iVₚᵢₗₑ*, iv_{ctep}* contained in the block 34 and decrypts them using the key sk_{CPU} contained in the memory 29. The module 28 initializes the values contained in the registers iv_{msbi}, iv_{ctei}, iv_{isbi}, iv_{msbd}, iv_{cted}, ivₚᵢₗₑ, iv_{ctep} using the decrypted cryptograms iv_{msbi}*, iv_{ctei}*, iv_{isbi}*, iv_{msbd}*, iv_{cted}*, ivₚᵢₗₑ*, iv_{ctep}*, respectively. At the end of step 162, the key ka and the initialization vector ivₖ used to decrypt the first basic block of the machine code 32 are contained in the memory 29.

After the step 162, the microprocessor 2 executes, one after the other, the basic blocks starting with the first basic block BB₁ of the machine code 32.

The execution of each basic block consists in executing, in the order in which the instruction lines LIⱼ of this basic block are stored in the memory 4, the instructions coded by each of these instruction lines.

For each of the instruction lines LIⱼ to be executed of the machine code 32, the microprocessor 2 executes the following steps.

In a step 164, the microprocessor 2 loads, into a register of the set 12, the instruction line stored at the address @ⱼ contained in the program counter 26.

Next, the module 28 proceeds to a step 166 of securing the instruction coded in the loaded instruction line.

The way in which step 166 works is now described in the case of the line LIⱼ. More precisely, in step 166, the module 28 carries out in succession the following operations.

In an operation 170, the module 28 verifies whether there is an error in the cryptogram CIⱼ* or the code MACⱼ using the code ECC_{Lj} contained in the loaded line LIⱼ. For example, to do this, the module 28 constructs, using a function programmed beforehand and the cryptogram CIⱼ* and the code MACⱼ, a code ECC_{Lj}′. If the code ECC_{Lj}′ is different from the code ECC_{Lj}, then an error is detected. If an error is detected, the module 28 immediately proceeds to a step 172.

In step 172, the module 28 triggers the signalling of an execution fault.

Here, in parallel to step 172, if an error is detected, the module 28 proceeds with an operation 174. In the operation 174, it corrects the cryptogram CIⱼ* and the code MACⱼ using the information contained in the code ECC_{Lj}. At the end of step 174, the corrected cryptogram CIⱼ* and the corrected code MACⱼ are used instead of the cryptogram CIⱼ* and code MACⱼ contained in the line LIⱼ, respectively.

The operation 170 notably allows faults introduced into the instruction line stored in the memory 4 to be detected and corrected.

At the end of the operation 174 or if no error was detected during the operation 170, the method continues with an operation 176.

During the operation 176, the module 28 verifies the integrity and authenticity of the cryptogram CIⱼ* using the code MACⱼ. For example, to do this, the module 28 constructs a label of the cryptogram CIⱼ*, then encrypts this label with the key k′ contained in its memory 29. If the cryptogram thus constructed is identical to the loaded code MACⱼ, then the integrity and authenticity of the cryptogram CIⱼ* are confirmed. In this case, the module 28 proceeds with an operation 178. In the contrary case, the module 28 proceeds with step 172.

The operation 176 on the one hand allows the authenticity of the loaded line of code to be validated but also allows, during the operation 174, it to be validated whether the cryptogram CIⱼ* and/or the code MACⱼ have been correctly corrected. The verification of authenticity prevents the replacement of the line of code with another line of code constructed by an author who did not know the key k′.

During the operation 178, the module 28 decrypts the cryptogram CIⱼ* using the key ka and the initialization vector ivₖ to obtain the decrypted instruction Iⱼ and the decrypted code ECC_{Ij}. The key ka was stored in the memory 29 in step 162. The vector ivₖ required to decrypt the cryptogram CIⱼ* was stored in the registers iv_{msbi} iv_{ctei} and iv_{lsbi} during the execution of the instruction “Branch @xx” or “BranchIV rd” or “BranchIV ra” coded in the basic block preceding the block that contains this currently processed line LIⱼ. If the line LIⱼ is contained in the first basic block BBᵢₙᵢ of the machine code 32, it is the initial values of the registers iV_{msbi}, iv_{ctei} and iv_{lsbi} that are used.

Here, it is the execution of the branch instruction “Branch @xx” or “BranchIV rd” or “BranchIV ra”, by the unit 10, that indicates to the module 28 that it must replace the content of the register iv_{isbi} with the content of the register iv_{branch}. The content of the register iv_{branch} is updated during the execution of the instruction “Load ivₓₓ” or “LoadIV rd”” or “LoadIV ra” that proceeds the branch instruction.

Next, in an operation 180, the module 28 stores the decrypted instruction Iⱼ and the decrypted code ECC_{Ij} in the queue 22.

Once the unit 10 has executed all the instructions that precede the instruction Iⱼ in the queue 22, i.e. when the instruction Iⱼ is the next instruction to be executed by the unit 10, the module 28 proceeds with an operation 184.

During the operation 184, the module 28 verifies whether there is an error in the instruction Iⱼ contained in the queue 22 using the code ECC_{Ij} associated with the instruction Iⱼ and contained in the same queue 22. This operation is carried out in a similar way to the operation 170.

If the module 28 detects an error, then it immediately proceeds with step 172. In addition, in parallel, in an operation 186, the module 28 corrects the instruction Iⱼ using the code ECC_{Ij}. The operation 186 is similar to the operation 174.

Next, at the end of the operation 186 or if no error was detected in the operation 184, the step 166 ends and the method continues with a step 190 of executing the instruction Iⱼ with the unit 10.

In step 190, the unit 10 executes the instruction

As shown in FIG. 7, in parallel to step 190, the method may comprise:
a step 198 of securing the call stack 46, and/or
a step 250 of securing the processed data.

These steps 198 and 250 are described in more detail in the following sections.

The operation 184 allows a modification of the instruction Iⱼ made between the time at which it was stored in the queue 22 and the time at which it is executed by the unit 10 to be detected.

The operation 184 also allows an execution fault to be signalled if the control flow of the machine code 32 has been modified. Specifically, a modification of the control flow manifests itself by the fact that after the execution of the basic block BBₖ₋₁ it is not the basic block BBₖ that is executed but another basic block BBₜ. In this case, during the execution of the block BBₖ₋₁, the initialization vector ivₖ₋₁ is loaded into the registers iv_{msbi}, iv_{ctei} and iv_{isbi}. Thus, during the execution of the block BBₜ, the cryptogram CIⱼ* is decrypted using the vector ivₖ that corresponds to BBₖ and not using the vector ivₜ that corresponds to the block BBₜ. Therefore, the decryption of the cryptogram CIⱼ* using the vector ivₖ leads to the obtainment of an incorrect instruction Iⱼ and of an incorrect code ECC_{Ij} and this is detected in the operation 184. The operation 184 makes it possible to detect a disruption in the execution not only of the operation “Branch @XX” but also of the operation “BranchIV ra” or “BranchIV rd”.

The operation 184 also allows the permutation, in the memory 4, of the two basic blocks BBₖ and BBₜ of the second type to be detected. Specifically, if the block BBₖ is replaced by the block BBₜ, then, during the execution of the instruction “Load IV ra” of the block BBₖ₋₁, the first data line of the block BBₜ is decrypted using a vector ivⱼ constructed using the address @ₖ and not using the address @ₜ. This therefore leads to an incorrect decryption of the cryptogram iv_{isbi}* and therefore to an incorrect decryption of the first instruction line of the block BBₜ. This incorrect decryption of the first instruction line of the block BBₜ is detected in the operation 184.

During the execution of the machine code 32, if attacks lead to the alteration of an instruction to be protected or to the modification of the control flow, the microprocessor 2 signals, in step 172, a fault in the execution of the machine code 32.

In response to such signalling, in a step 192, the microprocessor 2 implements a plurality of countermeasures. Very many countermeasures are possible. The countermeasures implemented may have very different degrees of severity. For example, the countermeasures implemented may range from simply displaying or simply storing in memory an error message without interrupting the normal execution of the machine code 32 up to definitively taking the microprocessor 2 out of service. The microprocessor 2 is considered to be out of service when it is definitively placed in a state in which it is incapable of executing any machine code. Between these extreme degrees of severity, there are many other possible countermeasures such as:
indicating, by way of a human-machine interface, the detection of faults,
immediately interrupting the execution of the machine code 32 and/or resetting it, and
deleting the machine code 32 from the memory 4 and/or deleting the backup copy 40 and/or deleting the secret data.

In addition, here the countermeasure implemented in step 192 may be selected depending on the detected error and therefore depending on the operation that led to the detection of this fault. For example, the selected countermeasure will change depending on whether the error was detected in operation 176 or 184.

### SECTION IV: SECURING THE DATA OF THE CALL STACK

Each time a calling function triggers the execution of a called function, the execution context of the calling function is saved in the stack 46. In addition, the called function also saves in the stack 46 data such as local variables.

Similarly to the case of the instructions Iⱼ, a datum Dⱼ stored in the stack 46 may be corrupted by buffer overflow attacks or by other types of attacks such as a fault-injection attack.

To make the stack 46 more robust to such attacks, here, each datum Dⱼ stored in the stack 46 is coded in a respective line LDⱼ. The line LDⱼ is a data line. Contrary to the instruction lines LIⱼ described in section III, each line LDⱼ codes a datum Dⱼ to be processed by the microprocessor and not an instruction Iⱼ executable by the unit 10.

The structure of a line LDⱼ is shown in FIG. 8. Here, the structure of the line LDⱼ is identical to the structure of the line LIⱼ except that the cryptogram CIⱼ* has been replaced by a cryptogram CDⱼ*. Given that the codes MACⱼ and ECC_{Lj} of the line LDⱼ are computed as already described in the case of the lines LIⱼ, they are here designated by the same symbols and are not described again.

The cryptogram CDⱼ* is obtained by encrypting, with the function fₖₐ, a concatenation CDⱼ. Here, the function fₖₐ is the same as that already described in the case of the lines LIⱼ. Thus, the cryptogram CDⱼ* is obtained using the following relationship: CDⱼ*=fₖₐ(CDⱼ; ivₚ). The function fₖₐ is programmed beforehand in the module 28.

Similarly to the vector ivₖ, the vector ivₚ is coded on 128 bits. The 32 most significant bits are stored in a register ivₚᵢₗₑ of the microprocessor 2. The 32 least significant bits are stored in a register iv_{lsbp} of the microprocessor 2. The 64 bits located between the 32 least significant bits and the 32 most significant bits are stored in one or more registers of the microprocessor 2 collectively designated by the term “register iv_{ctep}”. Each vector ivₚ is therefore the result of the concatenation of the bits of the registers ivₚᵢₗₑ, iv_{ctep} and iv_{lsbp}. Here, the content of the register iv_{ctep} remains constant throughout the whole execution of the machine code. For example, the register iv_{ctep} is loaded with this constant value at the start of the execution of the machine code 32. Here, the value contained in the register iv_{ctep} is obtained by decrypting the cryptogram iv_{ctep}* of the block 34. For example, the register iv_{ctep} is loaded at the start of the execution of the code 32 with a constant value different from those contained in the registers iv_{ctei} and iv_{cted}.

The content of the register iv_{lsbd}, which is used to encrypt the data, depends on the address @ⱼ at which the line LDⱼ containing this datum is stored. Specifically, the module 28 uses the function Fᵢᵥ described above. There is therefore the following relationship: iv_{lsbd}=Fᵢᵥ(@ⱼ), where iv_{lsbd} designates the content of the register iv_{lsbp}.

The concatenation CDⱼ is the concatenation of the datum Dⱼ and of a code ECC_{Dj}. The code ECC_{Dj} allows an error in the datum Dⱼ to be detected and corrected. It is typically constructed as described for the code ECC_{Ij}.

The cryptogram CDⱼ* differs from the cryptogram CIⱼ* in that the initialization vector ivₚ used during the encryption of the concatenation CDⱼ changes depending on the address of the line LDⱼ and also each time a new function stores data in the stack 46.

The way in which the data Dⱼ saved in the stack 46 are secured will now be described in more detail with reference to the method of FIG. 9 and in the particular case where they are implemented in combination with the teachings of the other sections. More precisely, the data Dⱼ are secured each time the instruction executed in step 190 is an instruction to read or write a datum Dⱼ from or to the stack 46. The method of FIG. 9 shows the operations executed in step 198 to secure the data Dⱼ.

Each time that, in the step 190, the unit 10 executes an instruction that leads to a new datum Dⱼ to be stored in a register, here denoted Rⱼ, of the set 12, in an operation 252, the module 28 computes the code ECC_{Dj} from the datum Dⱼ. This computed code ECC_{Dj} is then concatenated with the datum Dⱼ in the register Rⱼ.

Subsequently, during a new execution of the step 190, the unit 10 executes an instruction to store the datum Dⱼ contained in the register Rⱼ at the address @ⱼ in the stack 46.

In response, during operation 254, the module 28 constructs the line of code LDⱼ that must be stored at the address @ⱼ from the datum Dⱼ. To do this, during this operation, the module 28:
updates the content of the register iv_{lsbp} using the relationship iv_{lsbp}=Fᵢᵥ(@ⱼ), then
encrypts the concatenation CDⱼ of the datum Dⱼ and of the code ECC_{Dj} using the function fₖₐ and the initialization vector ivₚ by using the following relationship: CDⱼ*=fₖₐ(CDⱼ; ivₚ), then
computes the code MACⱼ from the cryptogram CDⱼ*, then
computes the code ECC_{Lj} from the cryptogram CDⱼ* and from the computed code MACⱼ.

Next, the constructed line LDⱼ is transferred and stored in the stack 46 at the address @ⱼ.

If the next instruction to be executed in step 190 is an instruction to load a line LDⱼ, then, the unit 10 executes this instruction and the line LDⱼ is loaded into a register of the microprocessor 2. Typically, this load instruction contains an operand that indicates at which address @ⱼ the line LDⱼ to be loaded is found. Here, when the unit 10 executes this load instruction, it loads the line LDⱼ into a register Rⱼ of the set 12 for example.

Next, the module 28 executes operations 270, 274, 276 and 278 that are identical to the operations 170, 174, 176 and 178, respectively, of the method of FIG. 7, except that it is the corresponding codes contained in the line LDⱼ that are used and not those contained in a line LIⱼ.

In addition, during the operation 278, the module 28 updates the content of the register iv_{lsbp} required to decrypt the cryptogram CDⱼ* using the address a and the relationship iv_{lsbp}=Fᵢᵥ(@ⱼ).

Once the cryptogram CDⱼ* has been decrypted, in an operation 280, the module 28 stores the decrypted datum Dⱼ and the decrypted code ECC_{Dj} in the register Rⱼ, while waiting for this datum to be processed by the unit 10.

When the next instruction that will be executed by the unit 10 is an instruction that processes the datum Dⱼ, the module 28 proceeds with operations 284 and 286. The module 28 identifies that the next instruction to be executed will process the datum Dⱼ because this instruction generally contains an operand that identifies the register Rⱼ in which the datum Dⱼ is stored. Operations 284 and 286 are, for example, identical to operations 184 and 186 of the method of FIG. 7, respectively, except that here it is the datum Dⱼ and code ECC_{Dj} that are used and not the instruction Iⱼ and the code ECC_{Ij}.

Next, at the end of the operation 286 or if no error was detected in operation 284, the unit 10 executes the instruction, which processes the datum Dⱼ.

The method for securing the data described here furthermore has the same advantages as those presented in section III notably because of the fact that the structure of the line LDⱼ is practically identical to that of the line LIⱼ.

In addition, the fact of encrypting the datum Dⱼ using an initialization vector iv_{lsbp} that depends on the address @ⱼ makes it possible to detect whether a line LDⱼ has been moved inside the stack 46. Specifically, if two lines LD₁ and LD₂ are permutated, such a permutation of the lines LD₁ and LD₂ is not necessarily detected in operation 270 or 276. In contrast, since the datum D₁ is encrypted with an initialization vector iv₁ that depends on the address @₁, if the line LD₁ is moved and is located at an address @₂ in the stack 46, during the loading of this line from this address @₂, the cryptogram CD₁* will be decrypted using the initialization vector iv₂ and not using the vector iv₁. Such an incorrect decryption of the datum D₁ and of the code ECC_{D1} is then detected in operation 284.

### SECTION V: SECURING AGAINST BUFFER OVERFLOW ATTACKS

As already explained with reference to FIG. 5, in the case of the RISC-V instruction set, when the function F₂ is called by the function F₁, the return address @ra2 to be used to continue the execution of the function F₁ after the execution of the function F₂ is stored in a register ra of the set 12. In contrast, if during the execution of the function F₂, a function F₃ is called, then, at this moment, the address @ra2 and, more generally, the execution context of the function F₂, is saved in the stack 46.

The execution context notably comprises all the information necessary to restart the execution of the function F₂ once the execution of the function F₃ has ended. It furthermore comprises:
the address @ra2,
the value of a pointer sp that points to the top of the stack 46,
potentially, the values of certain data in the process of being processed by the function F₂.

During its execution, the function F₃ may, it as well, save data in the stack 46, in a predefined space of the memory called the “buffer”. It is possible to write to this buffer data that are greater in amount than the space allocated to this buffer for saving these data. This leads to what is known as “buffer overflow”.

When this buffer overflow is generated intentionally, it may be used to replace the address @ra2 with another address @rat chosen by an attacker. Under these conditions, at the end of the execution of the functions F₂ and F₃, it is not the function F₁ that is executed, but instructions located at the address @rat. A buffer overflow may therefore be used to divert the control flow to code developed and designed by an attacker. Typically, this type of attack is employed to bypass security measures and/or to obtain secret information on the operation of the secure function.

In this section, one solution for combating this type of attack is described. Here, this solution is described in the particular case where the teaching of the other sections, and in particular of section IV, is implemented at the same time.

More precisely, to make buffer overflow attacks more difficult, the vector ivₚ used to encrypt the return address @ra2 saved in the stack 46 is different from that used by the called function F₃ when data is saved in the stack 46.

To this end, the prologue PF₃ and epilogue EF₃ of the call to the function F₃ are modified as shown in FIG. 10.

FIG. 10 is divided into three vertical columns designated by the references F₁, F₂ and F₃. The basic blocks of the functions F₁, F₂ and F₃ are shown in columns F₁, F₂ and F₃, respectively.

The instruction lines of the basic blocks of the functions F₁, F₂ and F₃ are secured as described in section III. Therefore, the basic blocks of the functions F₁, F₂ and F₃ are, either basic blocks of the first type, or basic blocks of the second type such as described above.

The function F₁ comprises a basic block 202 and a basic block 204. The block 202 is here a basic block of the first type. The basic block 202 ends with an instruction line that codes an instruction, denoted “Branch @F₂” in FIG. 10, to branch to the first instruction line of the first basic block 208 of the function F₂. It will be recalled here that when the instruction denoted “Branch @F₂” is executed, the return address @ra2 is stored in the register ra of the set 12.

The basic block 204 is the basic block of the function F₁ that must be executed when the execution of the function F₂ ends. Its first line is therefore located at the address @ra2. Here, the execution of the basic block 204 is triggered following the execution of an indirect branch instruction located at the end of the function F₂. Therefore, here, the basic block 204 is a basic block of the second type.

The function F₂ starts with the basic block 208 and ends with a basic block 214. Here, these basic blocks 208 and 214 are basic blocks of the first type.

Between these blocks 204 and 214, the function F₂ comprises a basic block 210 and a basic block 212. The basic block 210 contains the instruction lines of the prologue PF₃, which is executed by the microprocessor 2 before the start of the execution of the first basic block 220 of the function F₃.

The last instruction line of the prologue PF₃ codes a direct branch instruction, denoted “Branch @F₃”, to branch to the first instruction line of the block 220. During the execution of this instruction, the return address @ra3 of the function F₃ is stored in the register ra. Therefore, beforehand, the address @ra2 that was found in this register ra must be saved in the stack 46. To this end, the prologue PF₃ contains an instruction line denoted “Store @ra2, @ⱼ” that, when it is executed by the microprocessor 2, saves the address @ra2 at the address a in the stack 46. As explained in section IV, it is therefore a line LDⱼ containing a cryptogram CDⱼ* constructed from the address @ra2 that is saved at the address @ⱼ in the stack 46.

It will be recalled here that the cryptogram CDⱼ* is obtained using the vector ivₚ. This vector ivₚ is the result of the concatenation of the bits contained in the registers ivₚᵢₗₑ, iv_{ctep} and iv_{lsbp}. The content of the register iv_{lsbp} is equal to Fᵢᵥ(@ⱼ), where @ⱼ is the address in the stack 46 at which the datum must be saved.

Below, the value contained in the register ivₚᵢₗₑ at the moment at which the instruction “Store @ra2, @ⱼ” is executed is denoted ivₐ. Thus, the address @ra2 is encrypted using the value ivₐ contained in the register ivₚᵢₗₑ and the address @ⱼ.

Next, between the instructions “Store @ra2, @ⱼ” and “Branch @F₃”, the prologue PF₃ contains instruction lines coding instructions to:
save the value ivₐ in the stack 46, and
replace the value ivₐ of the register ivₚᵢₗₑ with a new value iv_{b}.

To this end, the prologue PF₃ contains in succession:
an instruction line coding an instruction denoted “LoadIV ivₜₑₘₚ, ivₚᵢₗₑ”,
an instruction line coding an instruction denoted “LoadIV ivₚᵢₗₑ, iv_{rnd}”, and
an instruction line coding an instruction denoted “StoreIV ivₜₑₘₚ, @ⱼ₊₁”.

When it is executed by the microprocessor 2, the invention “LoadIV ivₜₑₘₚ, ivₚᵢₗₑ” causes the content of the register ivₚᵢₗₑ to be stored in the register ivₜₑₘₚ. Thus, after the execution of this instruction, the value ivₐ is saved in the register ivₜₑₘₚ.

When it is executed by the microprocessor 2, the instruction “LoadIV iv_{rnd}” causes the content of the register iv_{rnd} to be stored in the register ivₚᵢₗₑ.

The register iv_{rnd} is here a register that is connected to a generator of random or pseudo-random numbers. Thus, each time its content is read from or loaded into another register, the register iv_{rnd} contains a new value constructed by the generator of random or pseudo-random numbers.

Thus, after the execution of the instruction “LoadIV ivₚᵢₗₑ, iv_{rnd}”, the register ivₚᵢₗₑ contains the new value iv_{b} and this new value iv_{b} was generated randomly or pseudo-randomly.

When the extraction “StoreIV ivₜₑₘₚ, @ⱼ₊₁” is executed by the microprocessor 2, it causes the value ivₐ contained in the register ivₜₑₘₚ to be saved in the stack 46 at the address denoted @ⱼ₊₁. For example, the address @ⱼ₊₁, is the address that immediately follows the address @ⱼ in the stack 46. Since the instruction “StoreIV ivₜₑₘₚ, @ⱼ₊₁” is executed after the instruction “LoadIV ivₚᵢₗₑ, iv_{rnd}”, the value ivₐ is encrypted using the new value iv_{b} contained in the register iVₚᵢₗₑ.

Lastly, as already described in section III, the prologue PF₃ also contains an instruction line coding the instruction “Load IV_{isbxx}” to load into the register iv_{branch} the value that will be used to decrypt the instructions Iⱼ of the following basic block, i.e., here, the basic block 220 of the function F₃.

The block 212 is the basic block of the function F₂ that is executed just after the execution of the function F₃. Since the execution of the basic block is triggered following the execution of an indirect branch, the block 212 is here a basic block of the second type.

The first basic block 220 of the function F₃ is a basic block of the first type.

The function F₃ ends with a basic block 222 of the first type that contains a first portion of the epilogue EF₃. This first portion EF₃ ends with an instruction line that codes an instruction “BranchIV ra”. When the instruction “BranchIV ra” is executed by the microprocessor 2, this causes a jump to the second line of the basic block 212. This instruction is preceded by an instruction line containing the instruction “Load IV ra”. These instructions have already been explained in section III.

The epilogue EF₃ also contains a second portion that starts at the first instruction line of the block 212. This second portion of the epilogue EF₃ contains in succession:
an instruction line coding an instruction “Load IV ivₚᵢₗₑ, @ⱼ₊₁”, then
an instruction line coding an instruction “Load ra, @ⱼ”.

The execution of the instruction “LoadIV ivₚᵢₗₑ, @ⱼ₊₁” by the microprocessor 2 causes the decryption of the datum contained in the data line located at the address @ⱼ₊₁, and said datum to be loaded into the register ivₚᵢₗₑ. As explained above, during the execution of the prologue PF₃, it is the cryptogram of the value ivₐ encrypted using the value iv_{b} that is saved in this line. Thus, the execution of the instruction “LoadIV ivₚᵢₗₑ, @ⱼ₊₁” causes the value iv_{b} contained in the register ivₚᵢₗₑ to be replaced with the value ivₐ saved in the stack 46.

The execution of the instruction “Load ra, @ⱼ” causes the datum contained in the data line located at the address @ⱼ to be decrypted, and said datum to be loaded into the register ra. As explained above, during the execution of the prologue PF₃, it is the cryptogram of the address @ra2 encrypted using the value ivₐ that is saved in this line. Thus, the execution of the instruction “Load ra, @ⱼ” causes the datum contained in this line to be decrypted and said datum to be loaded into the register ra.

The operation of the method for securing the stack 46 against buffer overflow attacks will now be described in more detail with reference to FIGS. 11 and 12 in the particular case of the functions F₁, F₂ and F₃ described above. The instructions of the functions F₁, F₂ and F₃ are executed in accordance with the description given in section III. It is also assumed that the function F₁ is the main function, also known as the “main”, of the machine code 32.

In a step 230, during the execution of the function F₁, the block 202 is executed in order to call the function F₂. During the execution of the block 202, the prologue of the call to the function F₂ is executed. The execution of this prologue causes the address @ra2 to be loaded into the register ra of the microprocessor 2. It also causes at least one portion of the execution context of the function F₁ to be saved in the stack 46. Next, the instruction “Branch @F₂” is executed, this causing a jump to the first instruction line of the function F₂ located at the address @208.

In a step 232, the function F₂ executes. During its execution, the function F₂ saves in the stack 46 data DF₂ (FIG. 12) such as, for example, local variables. Each time a datum is saved in the stack 46, the method of section IV is implemented. During the execution of the function F₂, the register ivₚᵢₗₑ contains the value ivₐ.

In a step 234, during the execution of the function F₂, the block 210 is executed. The prologue PF₃ of the call to the function F₃ is then executed by the microprocessor 2.

In step 234, the operations conventionally executed during the execution of a prologue of a call to a function are carried out. Since these operations are conventional, they are not described here. It will simply be recalled that the execution of these operations causes various data of the execution context of the function F₂ to be saved in the stack 46. These data for example comprise the value of a pointer sp that points to the top of the stack 46 and other information necessary to correctly restart the execution of the function F₂ after the execution of the function F₃. In addition, the execution of the prologue PF₃ leads the instruction lines shown in FIG. 10 to be executed one after the other. The execution of these instruction lines by the microprocessor 2 causes, in order:
the address @ra2 to be saved to the top of the stack 46, then
the current value ivₐ of the register ivₚᵢₗₑ to be saved in the register ivₜₑₘₚ, then
the new value iv_{b} to be loaded into the register ivₚᵢₗₑ, then
the value ivₐ contained in the register ivₜₑₘₚ to be saved in the stack 46, then
a new value to be loaded into the register iv_{lsbi} allowing the instruction lines LIⱼ of the block 220 to be decrypted, then
the first instruction line of the block 220 to be executed.

The address @ra2 is saved in the stack 46 like all the other data saved in the stack, i.e. by implementing the method of section IV. The address @ra2 is saved in the stack 46 at a moment at which the value contained in the register ivₚᵢₗₑ is equal to the value ivₐ. Therefore, it is only a cryptogram @ra2* obtained by encrypting the address @ra2 using the value ivₐ that is stored in the stack 46. In FIG. 12, this cryptogram is denoted “@ra2*”. Similarly, the value ivₐ is saved in the stack 46 by implementing the method of section IV. At the moment at which the value ivₐ is saved, the register ivₚᵢₗₑ contains the value iv_{b}. Thus, the cryptogram ivₐ* of the value ivₐ saved in the stack 46 is obtained by encrypting the value ivₐ using the value iv_{b}.

In a step 236, after the execution of the prologue PF₃, the function F₃ is executed. During its execution, the function F₃ stores data DF₃ in the stack 46 by implementing the method of section IV. Here, the function F₃ is a leaf function, i.e. a function that calls no other functions during its execution. Under these conditions, the content of the register ivₚᵢₗₑ is left unchanged between the execution of the prologue PF₃ and the execution of the epilogue EF₃. Thus, each datum saved in the stack 46 by the function F₃ is encrypted using the value iv_{b}, which is different from the value ivₐ.

In a step 238, when the execution of the function F₃ ends, the epilogue EF₃ is executed. The execution of the epilogue EF₃ causes, in addition to the execution of the conventional operations of an epilogue:
1) The cryptogram iv_{lsbxx}* contained in the first data line of the block 212 to be decrypted and the decrypted value to be loaded into the register iv_{lsbi} (execution of the instruction “LoadIV ra”), then
2) The first instruction line of the block 212 to be jumped to (execution of the instruction “Branch IV ra”), then
3) The value iv_{b} contained in the register ivₚᵢₗₑ to be replaced with the value ivₐ (execution of the instruction “Load IV ivₚᵢₗₑ, @ⱼ₊₁”), then
4) The address @ra2 to be loaded from the stack 46 into the register ra (execution of the operation “Load ra, @ⱼ”).

Operations 1) and 2) above have already been described in detail in section III.

In operation 3) above, the cryptogram ivₐ* is read from the stack 46 then decrypted using the value contained in the register ivₚᵢₗₑ, i.e. using the value iv_{b}.

During operation 4) above, the cryptogram @ra2* is read from the stack 46 and decrypted using the current value contained in the register ivₚᵢₗₑ, i.e., at this stage, using the value ivₐ.

Next, in an operation 240, the execution of the function F₂ continues using the value ivₐ contained in the register ivₚᵢₗₑ to decrypt and encrypt the data DF₂ saved in the stack 46.

In a step 242, when the execution of the function F₂ has ended, the execution of the function F₁ restarts. To this end, the branch to the address @ra2 contained in the register ra is executed. Here the switch from the execution of the function F₁ to the function F₂, then the return from the execution of the function F₂ to the function F₁ are implemented as described in detail in the case of the functions F₂ and F₃.

If a buffer overflow attack is carried out, forcing the function F₃ to store a datum that exceeds the size of the space allocated to save the data DF₃, then the cryptogram @ra2* may be replaced by another cryptogram denoted @rat*. Since the replacement of the cryptogram @ra2* by the cryptogram @rat* occurs during the execution of the function F₃, the cryptogram @rat* is the result of the encryption of an address @rat using the value iv_{b} currently contained in the register ivₚᵢᵢₑ.

During the execution of the epilogue EF₃, the cryptogram @rat* is decrypted using the value ivₐ and not using the value iv_{b}. Thus, the decrypted return address is different from the address @rat. The attacker can therefore not choose the address to which the control flow is diverted.

Lastly, in this embodiment, which also implements what was described in section IV, the attacker does not know the keys ka and k′. He cannot therefore correctly construct a code MACⱼ and the cryptogram CDⱼ* corresponding to the address @rat. Thus, if the data line containing the cryptogram @ra2* is replaced by a data line containing the cryptogram @rat*, such a replacement is detected during the verification operations 270 and 276. Thus, an execution error is detected before the execution of the block 214.

### SECTION VI: SECURING THE DATA

The binary code 30, in addition to the machine code 32, may contain data to be processed during the execution of the machine code 32. In addition, during the execution of the machine code 32, the latter may generate data. These data are typically contained in portion 44 of the memory 4.

What was described in section IV with respect to securing the data saved in the stack 46 is, preferably, also implemented to secure the data stored in portion 44. In particular, each datum stored in portion 44 is coded in a line LDⱼ the structure of which is identical to the case of the stack 46. Thus, a datum is written to and read from the portion 44 as described in section IV, except that the term “stack 46” must be replaced with the term “portion 44”.

### SECTION VII: GENERATION OF THE BINARY CODE

FIG. 13 shows a compiler 300 able to automatically generate the binary code 30 from a source code 302. To this end, the compiler 300 typically comprises a programmable microprocessor 304 and a memory 306. The memory 306 contains the instructions and data required to, when they are executed by the microprocessor 304, automatically generate the binary code 30 from the source code 302. In particular, during the compilation of the source code 302, the microprocessor 304 automatically generates the appropriate initialization vectors ivₖ and the lines of code LIⱼ and LDⱼ. During this compilation, the compiler 300 also automatically inserts, into the machine code, the instructions described above, in order to implement the methods of FIGS. 7, 9 and 11. It is within the ability of those skilled in the art to design and produce such a compiler given the explanations given in this description. For example, the compiler 30 automatically notes and identifies branch instructions and, depending on the identified branch instruction, automatically inserts, before and/or afterwards, the instructions required to implement the methods described here.

### SECTION VIII: VARIANTS

Variants of the Device 1:

The memory 4 may also be a nonvolatile memory. In this case, it is not necessary to copy the binary code 32 to this memory before launching its execution since it is already found therein.

As a variant, the memory 4 may also be an internal memory integrated into the microprocessor 2. In the latter case, it is produced on the same substrate as the other elements of the microprocessor 2. Lastly, in other configurations, the memory 4 is composed of a plurality of memories, certain of which are internal memories and others of which are external memories.

The main memory 4 may comprise a first volatile memory of large capacity and a second volatile memory of smaller capacity but in which read and write operations may be carried out more rapidly. The second memory is what is known as a cache memory. The cache memory may be a memory external to the microprocessor 2 or a memory internal to the microprocessor 2. In certain embodiments, a plurality of cache memories of different levels may be used.

Many different hardware architectures may be used to produce the module 28. In particular, the module 28 may be composed of a combination of a plurality of hardware blocks of the microprocessor 2 performing respective functions and each located in a different area of the chip of the microprocessor 2.

In another embodiment, the module 28 is replaced by a software module that, when it is executed by the unit 10, performs the same functions and operations as those described with respect to the module 28.

Variants of the Way in which the Machine Code is Secured:

As a variant, only the structure of the second type, i.e. the structure described with reference to FIG. 5, is used for all the basic blocks of the machine code 32. In this case, what was described above in the particular case of indirect branches also applies to the direct branches.

Other embodiments of the content of the first line of a block BBₖ of the second type are possible. For example, this content is not necessarily encrypted. In another variant, this content is encrypted using a key other than the address @ₖ of the first line. For example, the content of the first line is only encrypted with the key ka. The content of the first line of may also contain, instead of the cryptogram iv_{lsbi}*, a cryptogram @_{lsbi}* of an address @_{lsbi}. In this case, when the instruction “Load IV ra” or “LoadIV rd” is executed, it causes the cryptogram @_{lsbi*} to be read and decrypted in order to obtain the address @_{lsbi}. Next, the content from which the 32 least significant bits of the vector ivₖ are constructed is read at the address @_{lsbi}.

To construct the vector ivₖ from the address @ₖ, other embodiments are possible. For example, a lookup table is loaded into the memory 29 before or at the start of the execution of the code 32. In this table, the content that allows the 32 least significant bits of the vector ivₖ to be constructed is associated with each address @ₖ of a block BBₖ of the second type. For example, this content is identical to that described in the case where it is stored in the first line of the basic block of the second type. The operation of this embodiment is identical to that described above except that the instruction “LoadIV ra” or “LoadIV rd” causes, when it is executed by the microprocessor 2, the content of the register iv_{lsbi}, to be read from the lookup table and not from the first line of the basic block BBₖ. In this case, the basic blocks of the second type are replaced by basic blocks of the first type and the instruction “BranchIV rd” or “BranchIV ra” is modified to cause a jump to the first line of the following basic block and not to the second line of this basic block.

It is also not necessary to construct the vector ivₖ using the contents of the registers iv_{msbi} and iv_{ctei}. For example, as a variant, the contents of the registers iv_{msbi} and iv_{ctei} are constructed from the content of the register iv_{lsbi}. For example, the vector ivₖ coded on 128 bits is obtained by concatenating the 32 bits of the register iv_{lsbi} four times with themselves. In this case, the registers iv_{msbi} and iv_{ctei} may be omitted.

As a variant, certain functions or portions of the binary code 30 are insecure. To manage the execution of such a binary code, which comprises both a secure function and insecure functions, the instruction set of the microprocessor 2 may be completed by:
an instruction to activate a secure operating mode of the microprocessor 2, and
an instruction to deactivate this secure mode.

In this case, the instruction to activate the secure mode is located in the binary code 30 just before the call to the secure function and the instruction to deactivate the secure mode is located just after the end of the secure function. When the instruction to activate the secure mode is loaded by the microprocessor 2, in response, the module 28 starts to process the following instructions and data of the binary code as described in the preceding sections. When the instruction to deactivate the secure mode is loaded by the microprocessor 2, in response, the module 28 is deactivated. In the latter case, the following instructions and data of the binary code are not processed by the module 28 but loaded directly into the queue 22 or into the registers of the set 12.

As a variant, an “update” instruction is added to the instruction set of the microprocessor. When this “update” instruction is executed by the microprocessor 2, it causes the value currently contained in the register iv_{branch} to be loaded into the register iv_{lsbi}. Thus, in this case, the use of a new initialization vector ivₖ is triggered in a different manner than by execution of a branch instruction. In this case, the described method may also be implemented with implicit branch instructions. Specifically, the last instruction of a basic block that ends with an implicit branch instruction is then the “update” instruction. Instead of the “update” instruction being a separate instruction in the instruction set of the microprocessor, it is possible to add an additional bit to each instruction of the instruction set of the microprocessor 2 and to trigger the change of initialization vector ivₖ solely when this additional bit takes a specific value.

The code ECC_{Ij} may be replaced by a simple error detection code only allowing an error to be detected in the instruction I_{J} with which it is concatenated. An error detection code does not allow the detected error to be corrected. In this case, the operation 186 of correcting the error is omitted. Thus, it soon as the module 28 detects an error in a decrypted instruction Iⱼ, for example, the execution of the secure function is systematically interrupted.

In a simpler variant, the code ECC_{Ij} is omitted. In this case, the cryptogram CIⱼ* is merely the cryptogram of the instruction Iⱼ. In this embodiment, the microprocessor 2 is no longer capable of detecting modifications of the instruction Iⱼ that occur between the time at which said instruction is stored in the queue 22 and the time at which it is executed by the unit 10.

The code ECC_{Lj} may be replaced by a simple error detection code. In this case, the correcting operation 174 is omitted.

In another variant, the code ECC_{Lj} is constructed so as to only allow the detection of an error, either only in the cryptogram CIⱼ* or only in the code MACⱼ.

The code ECC_{Lj} may be omitted. In this case, an error in the cryptogram CIⱼ* or in the code MACⱼ can be detected only during the execution of the operation 176 for verifying the integrity and authenticity of the cryptogram. It is generally more complex to detect an error with a MAC code than with a simple error detection code or a simple error correction code. In addition, when the code ECC_{Lj} is omitted, in the case where there is an error in the cryptogram CIⱼ* or the code MACⱼ, it is not possible to correct this error. In the latter case, for example, the execution of the secure function is therefore systematically interrupted in case of error.

In another embodiment, it is the code MACⱼ that is omitted. The operation 176 is then also omitted.

Variants of the Way in which the Data are Secured:

The structure of the lines LDⱼ used to secure the data saved in the memory 4 may be modified. In particular, the various variants of the structure of a line LIⱼ described above are applicable to the structure of the lines LDⱼ. When the structure of the line LDⱼ is modified, the method of FIG. 9 must be correspondingly modified to take into account these modifications. For example, if the code ECC_{Dj} is replaced by a simple error detection code, then the error-correcting operation 286 is omitted. Thus, as soon as the module 28 detects an error in a decrypted datum Dⱼ, for example, the execution of the secure function is systematically interrupted.

As a variant, the function Fᵢᵥ is identical to the function fₖₐ except that it is applied to the address @ⱼ. The function Fᵢᵥ may also use the same encryption algorithm as the function fₖₐ, but with an encryption key different from the key ka.

In a simpler variant, the function Fᵢᵥ is the identity function. In this case, the contents of the registers iv_{lsbd} and iv_{lsbp} are systematically equal to the address @ⱼ.

In other embodiments, to detect a movement of a line LDⱼ, the code MACⱼ is computed depending on the vector ivₚ. For example, in the case of a data line LDⱼ saved in the stack 46, the code MACⱼ is computed from the concatenation of the cryptogram CDⱼ* and of the vector ivₚ. The code MACⱼ may also be computed from a combination of the cryptogram CDⱼ* and of the vector ivₚ, i.e. a combination such as the following one: CDⱼ* XOR ivₚ. In the case where the code MACⱼ depends on the vector ivₚ, then it may be used instead of the code ECC_{Dj} to detect an error in case of movement of the line LDⱼ in the stack 46. Specifically, in this case, during the verification of the integrity and of the authenticity of the cryptogram CDⱼ*, the module 28:
obtains the vector ivₚ from the content of the registers ivₚᵢₗₑ, iv_{ctep} and iv_{lsbp}, then
combines the cryptogram CDⱼ* with the obtained vector ivₚ, then
verifies the integrity and authenticity of this combination using the code MACⱼ contained in the same line LDⱼ.
   If this line LDⱼ has been moved, the obtained vector ivₚ is different from that expected. As a result, the integrity of the combination of the cryptogram CDⱼ* and of the vector ivₚ cannot be verified, this triggering the signalling of an execution fault. It will be noted that, in this embodiment, it is possible to detect a movement of the line LDⱼ without even having to decrypt the cryptogram CDⱼ*. In this variant, to detect a movement of the line LDⱼ, the code ECC_{Dj} may be omitted.

Similarly to what was described above with respect to the code MACⱼ, the code ECC_{Lj} may also be constructed so as to depend on the vector ivₚ. In this case, the movement of the line LDⱼ is detected during the verifications of the code ECC_{Lj}. As a result, to detect a movement of the line LDⱼ, the code ECC_{Dj} may be omitted.

In the embodiments described up to now, both the datum Dⱼ and the code ECC_{Dj} are coded depending on the vector ivₚ since the cryptogram CDⱼ* is encrypted using this vector ivₚ. As a variant, either only the datum Dⱼ or only the code ECC_{Dj} is coded depending on the vector ivₚ. For example, in the data line, the cryptogram of the datum Dⱼ is obtained using an encryption function that does not use the vector ivₚ, whereas the cryptogram ECC_{Dj}* of the code ECC_{Dj} is obtained using the encryption function fₖₐ(ECC_{Dj}; ivₚ). In this case, in the operation 278, the module 28 decrypts the cryptogram of the datum Dⱼ without using the vector ivₚ and decrypts the cryptogram ECC_{Dj}* using this vector ivₚ. Next, the rest of the method is identical to what was described above. In one simpler embodiment, since there is no need to code the datum Dⱼ depending on the vector ivₚ, it is also possible to not encrypt it. For example, the line of code then contains the datum Dⱼ in plaintext and the cryptogram ECC_{Dj}*. As a result, in the operation 278, the decryption of the datum Dⱼ is omitted since it is enough to extract it from the bit range in which it is contained in the line LDⱼ.

Conversely, it is also possible to modify the structure of the lines LDⱼ so that only the datum Dⱼ is coded depending on the vector ivₚ. For example, the line LDⱼ contains a cryptogram Dⱼ* of the datum Dⱼ obtained by encrypting it using the function fₖₐ(Dⱼ; ivₚ) and a cryptogram ECC_{Dj}* obtained by encrypting the code ECC_{Dj} using an encryption function independent of the vector ivₚ. In operation 270, the module 28 decrypts the cryptogram Dⱼ* using the vector ivₚ and decrypts the cryptogram ECC_{Dj}* without using this vector ivₚ.

Up to now, it has been an encryption function that has been described by way of an example of an embodiment allowing the datum Dⱼ or the code ECC_{Dj} to be coded depending on the vector ivₚ. This encryption function may however be none other than a simple “Exclusive OR” logic operation that compares the datum Dⱼ and the vector ivₚ or the code ECC_{Dj} and the vector ivₚ.

All the variants described in the particular case of securing data saved in the stack 46 apply to the case of securing data saved elsewhere in the memory 4. In particular, these variants apply to the data line LDₖ of the basic blocks of the second type.

Variants of the Way in which the Call Stack is Secured:

The way in which the stack 46 is secured was described for the particular case in which the return address @ra2 is saved in the stack only at the moment at which the function F₂ calls the function F₃. However, what was described also applies to situations in which the return address @ra2 is saved in the stack 46 at the moment at which the function F₂ is called by the function F₁. In this case, what was described above may be applied unchanged, except that it is the prologue and epilogue of the function F₂ that are modified.

The new value iv_{b} contained in the register ivₚᵢₗₑ may be generated in many different ways. For example, the new value iv_{b} is equal to the value ivₐ to which a preset increment has been added. In this case, the initial value contained in the register ivₚᵢₗₑ is for example a predefined value loaded on start-up of the microprocessor 2.

There are other possible ways of encrypting the address @ra2 using an initialization vector different from that used to encrypt the data DF₃. For example, as a variant, the prologue PF₃ is modified to perform in order the following operations when it is executed by the microprocessor 2:

1) The value ivₐ contained in the register ivₚᵢₗₑ is saved in a register ivₜₑₘₚ₁.
2) The value ivₐ contained in the register ivₚᵢₗₑ is replaced by a new value iv_{b} generated, for example, randomly as described above.
3) The address @ra2 contained in the register ra is saved in the stack 46. The cryptogram @ra2* stored in the stack 46 is therefore the result of the encryption of the address @ra2 using the value iv_{b} currently contained in the register ivₚᵢₗₑ.
4) The value iv_{b} contained in the register ivₚᵢₗₑ is saved in a register ivₜₑₘₚ₂.
5) The value iv_{b} contained in the register ivₚᵢₗₑ is replaced by the value ivₐ contained in the register ivₜₑₘₚ₁.
6) The value iv_{b} contained in the register ivₜₑₘₚ₂ is saved in the stack 46. The cryptogram iv_{b}* stored in the stack 46 is therefore the result of the encryption of the value iv_{b} using the value ivₐ currently contained in the register ivₚᵢₗₑ.

Next, during the execution of the function F₃, each time data are saved in the stack 46, said data are encrypted using the value ivₐ contained in the register ivₚᵢₗₑ. This embodiment therefore indeed allows the address @ra2 to be encrypted using an initialization vector different from that used to encrypt the data saved in the stack 46 during the execution of the function F₃. The operation of this embodiment may be deduced from the explanations given with reference to FIGS. 10 to 12.

Other embodiments of the prologue PF₃ and of the epilogue EF₃ are possible. For example, if additional temporary registers are used, the order of the operations may be modified. Thus, for example, the cryptogram ivₐ* may be saved in the stack 46 before the cryptogram @ra2*. To do this, for example, it is necessary in succession to:

1) save the value ivₐ in a temporary register ivₜₑₘₚ₃,
2) generate and save the value iv_{b} in the register ivₚᵢₗₑ,
3) save the content of the register ivₜₑₘₚ₃ in the stack 46,
4) save the value iv_{b} in a register ivₜₑₘₚ₄,
5) restore the value ivₐ to the register ivₚᵢₗₑ on the basis of the content of the register ivₜₑₘₚ₃,
6) save the content of the register ra in the stack 46,
7) restore the value iv_{b} to the register ivₚᵢₗₑ on the basis of the content of the register ivₜₑₘₚ₄.

As a variant, only the return address is encrypted before being saved in the stack 46. The other data saved in the stack 46 are not encrypted or are encrypted using another key. For example, each return address saved in the stack 46 is encrypted, by the module 28, with the key ka whereas the other data saved in the stack 46 are not encrypted. In this case, if a datum stored in the stack 46 causes a buffer overflow that replaces the cryptogram @ra2* with a cryptogram @rat*, then, after the execution of the functions F₃ and F₂, the execution of the code continues with the execution of the instruction located at the address fₖₐ⁻¹(@rat*). However, the attacker does not know the key ka and can not therefore determine the address corresponding to fₖₐ⁻¹(@rat*). He cannot therefore predict to which address the execution of the code 30 will be diverted. This therefore also makes buffer overflow attacks more difficult.

In one much simpler embodiment, the data DF₃ saved in the stack 46 are not encrypted. In this case, the value ivₐ and the data DF₃ saved in the stack 46 are not encrypted. However, even in this simplified case, the fact that the address @ra2 saved in the stack 46 is encrypted in a different way to the data DF₃ makes buffer overflow attacks more difficult.

Variants Common to the Various Preceding Sections

From the moment that a line of code contains at least one of the elements of the group composed of a message authentication code, an error correction code and an error detection code, it is possible to detect a modification of the content of this line. Thus, to detect a modification of the content of an instruction line or a data line, only a single one of the elements of this group is necessary.

In one very simple embodiment, no error detection or correction codes and no codes MACⱼ such as described above are employed. In this case, an error in the decryption of a datum or of an instruction may lead to the unit 10 being unable to execute an instruction and therefore to the abrupt stoppage of the execution of the machine code 30.

The encryption and decryption were described in the particular case where the functions fₖₐ and fₖₐ⁻¹ are encryption algorithms that use an “initialization vector” and, preferably, also a secret key ka. However, the functions fₖₐ and fₖₐ⁻¹ may also be encryption/decryption algorithms in which an initialization vector is not necessary. However, if the term “initialization vector” is simply replaced by the term “key” everything that has been described here also applies to such an encryption/decryption algorithm.

The function used to generate the cryptogram CDⱼ* may be different from that used to generate the cryptogram CIⱼ*. For example, these two functions differ in that they use different encryption keys.

In another variant, the keys ka and k′ are the same.

The key ka may be stored beforehand in the memory 29. In this case, the cryptogram ka* may be omitted from the block 34.

The cryptogram k′* of the key k′ encrypted with the public key pk_{CPU} may be stored in the block 34. In this case, there is no need for the key k′ to be stored beforehand in the memory 29.

A line of code may be longer than one machine word. In this case, each line of code is composed of a plurality of machine words that are generally located at immediately consecutive memory addresses in the memory 4. In this case, a line of code is loaded into the microprocessor 2 not in a single read operation, but by executing a plurality of read operations. Each read operation loads into the microprocessor a respective machine word of the line of code.

As a variant, the operation 176 or 276 are systematically followed by the operation 178 or 278 even if the integrity or authenticity of the cryptogram was not able to be confirmed. In this case, the operation 176 or 276 serves to trigger the signalling of an execution fault without interrupting the execution of the binary code.

Depending on the instruction set used by the microprocessor 2, the described instructions, such as “LoadIV”, “BranchIV” and “StoreIV”, each correspond to a single instruction of this set or, in contrast, to a group of a plurality of instructions of this set.

Everything that was described in section III may be implemented independently of what was described in the other sections. For example, steps 198 and 250 may be omitted and the method of FIG. 11 not implemented.

Everything that was described in section IV may be implemented independently of what was described in the other sections. For example, what was described in section IV may be implemented:
in the context of a machine code devoid of indirect branch instruction and of instruction “LoadIV ra”,
without implementing the teaching of section III to secure the instructions of the machine code,
without implementing the teaching of section V to secure the stack 46 against buffer overflow attacks.

Everything that was described in section V may also be implemented independently of what was described in the other sections. For example, what was described in section V may be implemented:
in the context of a machine code devoid of indirect branch instruction and of instruction “LoadIV ra”,
without implementing the teaching of section III to secure the instructions of the machine code,
without implementing the teaching of section VI to secure the data stored in portion 44 of the memory 4.

All the embodiments described in this text and, in particular, the various variants, may be combined together.

### SECTION IX: ADVANTAGES OF THE DESCRIBED EMBODIMENTS

Advantages in Securing the Machine Code:

Since the loading of the vector iv_{lsci} required to decrypt the instruction lines of the basic block BBₖ is triggered during the execution of the basic block BBₖ₋₁, the integrity of the control flow is ensured. Specifically, if following execution of the basic block BBₖ₋₁, it is a basic block BBₜ that is executed instead of the basic block BBₖ, then the instruction lines of the basic block BBₜ are decrypted using the loaded vector ivₖ. The instruction lines of the basic block BBₜ are therefore not decrypted using the vector ivₜ used to encrypt these instruction lines of the basic block BBₜ. Thus, the decryption of the instruction lines of the block BBₜ is incorrect, this being detected. It is therefore difficult to divert the flow of execution of the block BBₖ to the block BBₜ.

The indirect load instruction does not directly contain the value of the vector ivₖ but solely the identifier of a register intended to contain the address @ₖ of the block BBₖ. Thus, the basic block BBₖ₋₁ only contains instructions that allow, at the moment of the execution of this basic block BBₖ₋₁, this vector ivₖ to be constructed from the content of the identified register. As a result, the basic block BBₖ₋₁ may be compiled independently of the following basic block BBₖ. By virtue of this, the use of an indirect branch at the end of a basic block is made possible while preserving the ability to control and guarantee the integrity of the control flow.

Recording the content to be loaded in the register iv_{lsbi} in the first line of the basic block of the second type allows this content to be easily loaded into the microprocessor. In addition, the insertion of such a first data line during the generation of the machine code is simple.

The fact that the content to be loaded in the register iv_{lsbi} is stored in the memory 4 in encrypted form, increases security.

The fact that the cryptogram iv_{isbi}* is decrypted using the address @ⱼ makes the permutation, in the memory 4, of two blocks of the second type difficult and detectable.

The encryption of the instructions Iⱼ makes it possible to guarantee the confidentiality of the binary code 30, this making reverse engineering of the binary code very difficult. The verification of the integrity of the cryptogram CIⱼ* or CDⱼ* allows modifications of the binary code caused, for example, by attacks such as the injection of faults into the memory 4 to be detected. Verifying the authenticity of the instructions and of the data makes it possible to detect and make very difficult the addition of additional instructions to the binary code 30 by an attacker who, for example, would like to insert therein malicious software such as viruses. Specifically, even if the attacker knows the algorithm used to encrypt the instructions Iⱼ or the data Dⱼ, he will not know the secret key k′ used to construct the code MACⱼ.

The verification, using the code ECC_{Ij} or ECC_{Dj}, of the existence of an error in the instruction Iⱼ or the datum Dⱼ just before it is used allows a modification of this instruction or of this datum Dⱼ to be detected. Such modifications may be caused by fault injection. Thus, the use of the code ECC_{Ij} or ECC_{Dj} allows this type of attack to be detected.

The fact that the code ECC_{Ij} or ECC_{Dj} is an error correction code and not merely an error detection code allows the executing method to be made more robust with respect to fault-injection attacks. Specifically, in this case, the error correction code often allows the error introduced into the instruction Iⱼ or into the datum Dⱼ to be corrected so that despite the presence of such errors, the secure function continues to execute correctly.

The use of the code ECC_{Lj} allows an error in the cryptogram CIⱼ* or CDⱼ* or in the code MACⱼ to be detected more rapidly than if only the code MACⱼ were used for this purpose. The use of the code ECC_{Lj} therefore allows the execution of the binary code to be accelerated.

The use of an error correction code for the code ECC_{Lj} allows the claimed method to be made more robust with respect to fault-injection attacks that inject faults into the memory 4 or into the medium 6. Specifically, in this case, the error correction code often allows the cryptogram CIⱼ* or CDⱼ* or the code MACⱼ to be corrected so that, despite the presence of such errors, the secure function executes correctly.

Advantages of Securing Against Buffer Overflow Attacks:

The fact of encrypting the address @ra2 of the calling function F₂ with a value ivₐ different from the value iv_{b} used when saving the data DF₃ of the called function F₃ makes it possible to make buffer overflow attacks more difficult.

Encrypting the data stored in the stack 46 increases the security of the method.

Encrypting the data saved in the stack depending on a value that depends in addition on the address at which the datum is saved in the stack makes it possible to permit random access to the data encrypted and saved in the stack 46, while making it difficult to permute two data lines stored in this call stack.

The use of an error detection code associated with each datum saved in the call stack makes it possible to detect whether the decryption of a datum has taken place correctly before this datum is exploited and processed during the execution of the machine code 30.

The decryption and encryption of the address @ra2 in addition to use of the key ka known only to and stored in the module 28 makes it possible to make the implementation of a buffer overflow attack even more difficult.

Making the code ECC_{Dj} an error correction code in addition allows a detected error to be corrected. This therefore allows the execution of the secure function to be continued even if an error was signalled.

1. A method for executing, with a microprocessor, a binary code containing a calling function and a called function, which is called by the calling function, said method comprising the following steps:
a) delivering the binary code, the delivered binary code containing a machine code containing:
a prologue of a call to the called function, said prologue containing a branch instruction that, when it is executed by the microprocessor, causes a branch to the first instruction line of the called function, and
an epilogue of the call to the called function, said epilogue containing a branch instruction that, when it is executed by the microprocessor, causes a branch to an instruction line of the calling function located at a return address,
b) executing the binary code with the microprocessor, the method comprising, during said execution:
executing the prologue and epilogue of the call to the called function, and
between the execution of the prologue and of the epilogue, cause data to be saved by the called function in a call stack,
wherein:
the execution of the prologue by the microprocessor comprises encrypting the return address of the calling or called function and saving the return address thus encrypted in the call stack, said encryption being carried out using a first value that is not used when data are saved in the call stack by the called function and that is independent of the address at which the return address thus encrypted is saved in the call stack, then
the execution of the epilogue by the microprocessor comprises decrypting, using said first value, the encrypted return address saved in the call stack, then
branching to the instruction line identified by said decrypted return address.

2. The method according to claim 1, wherein, between the execution of the prologue and of the epilogue of the called function:
each time a datum is saved in the call stack, the method comprises:
encrypting said datum using a second value, then
saving the datum thus encrypted in the call stack, the second value being different from the first value and independent of the address at which the datum is saved in the call stack,
each time a datum saved in the call stack must be read, the method comprises decrypting said datum using the second value.

3. The method according to claim 2, wherein:
the execution of the prologue by the microprocessor comprises:
encrypting the first value using the second value, then
saving in the call stack the first value encrypted using the second value,
the execution of the epilogue by the microprocessor comprises:
decrypting the encrypted first value saved in the call stack using the second value in order to obtain the decrypted first value, then
decrypting the encrypted return address saved in the call stack using the decrypted first value.

4. The method according to claim 2, wherein the encryption and decryption of data using the second value are also carried out using a third value that depends on the address at which the datum is saved in the call stack.

5. The method according to claim 1, wherein the encryption and decryption of the return address using the first value are also carried out using a third value that depends on the address at which the return address is saved in the call stack.

6. The method according to claim 1, wherein:
when a datum or a return address is saved in the call stack, the method comprises:
constructing a data line containing a cryptogram of the datum or of the return address and, in addition, an error detection code allowing an error in the decrypted datum or in the decrypted return address to be detected, then
storing the data line in the call stack, then
when a datum or a return address is read from the call stack, the method comprises:
decrypting the datum or return address,
verifying the existence of an error in the decrypted datum or decrypted return address using the error detection code contained in the same line, then
if there is an error in the decrypted datum or decrypted return address, triggering the signalling of an execution error and, in the contrary case, not triggering said signalling of an execution error.

7. The method according to claim 1, wherein, in step b):
the instructions of the machine code are executed by an arithmetic logic unit of the microprocessor,
the encryption and decryption of the return address saved in the call stack are carried out by a hardware security module that functions independently of the arithmetic logic unit, and
the encryption and decryption of the return address saved in the call stack are carried out in addition using a secret key stored only in the hardware security module.

8. A non-transitory computer program product embodied on a computer readable storage medium, comprising a binary code, executable by a microprocessor, for implementing an executing method according to claim 1, said binary code containing:
a calling function and a called function, which is called by said calling function,
a prologue of a call to the called function, said prologue containing a branch instruction that, when it is executed by the microprocessor, causes a branch to the first instruction line of the called function, and
an epilogue of the call to the called function, said epilogue containing a branch instruction that, when it is executed by the microprocessor, causes a branch to an instruction line of the calling function located at a return address,
between the prologue and the epilogue, write instructions that, when they are executed by the microprocessor, cause data to be saved by the called function in a call stack,
wherein:
the prologue contains instructions that, when they are executed by the microprocessor, cause the return address of the calling or called function to be encrypted and the return address thus encrypted to be saved in the call stack, said encryption being carried out using a first value that is not used when data are saved in the call stack by the called function and that is independent of the address at which the return address thus encrypted is saved in the call stack,
the epilogue contains instructions that, when they are executed by the microprocessor, cause the decryption, using said first value, of the encrypted return address saved in the call stack, and
the binary code contains a branch instruction that, when it is executed by the microprocessor, causes a branch to the instruction line identified by said decrypted return address.

9. (canceled)

10. A microprocessor for implementing a method according to claim 1, said microprocessor comprising an arithmetic logic unit and a hardware security module, wherein the hardware security module is configured to:
encrypt the return address of the calling or called function and save the return address thus encrypted in the call stack, said encryption being carried out using a first value that is not used when data are saved in the call stack by the called function and that is independent of the address at which the return address thus encrypted is saved in the call stack, then
decrypt, using said first value, the encrypted return address saved in the call stack.

11. A compiler able to automatically convert a source code of a function into a binary code of said function, wherein the compiler is able to automatically convert the source code into a binary code according to claim 8.
